(19) United States
(12) Patent Application Publication
(10) Pub. No.: US 2024/0278227 A1
(43) Pub. Date: Aug. 22, 2024

(54) ALIPHATIC ANION EXCHANGE POLYMERS

(71) Applicants: University of Delaware, Newark, DE (US); Versogen, Inc., Newark, DE (US)

(72) Inventors: Yushan Yan, Hockessin, DE (US); Junhua Wang, Newark, DE (US); Hui Duan, Newark, DE (US); Keda Hu, Newark, DE (US); Lan Wang, Newark, DE (US); Wenjuan Shi, Newark, DE (US)

(21) Appl. No.: 18/435,852

(22) Filed: Feb. 7, 2024

Related U.S. Application Data
(60) Provisional application No. 63/443,966, filed on Feb. 7, 2023.

(51) Int. Cl. B01J 41/14; H01M 8/1004; H01M 8/103; H01M 8/1081; H01M 8/1086

(52) U.S. Cl. CPC B01J 41/14; H01M 8/1004; H01M 8/103; H01M 8/1081; H01M 8/109

(57) ABSTRACT

Alkaline-stable cations were introduced to a polyolefin bearing phenyl side chains to enable manipulation of ion exchange capacity and hot pressing technique. Hydroxide exchange membranes or hydroxide exchange ionomers formed from these polymers exhibit superior chemical stability, hydroxide conductivity, decreased water uptake, good solubility in selected solvents, and improved device stability as compared to conventional hydroxide exchange membranes or ionomers. Hydroxide exchange membrane fuel cells and hydroxide exchange membrane electrolyzers comprising the polyolefin with pendant cation provide enhanced performance and durability at relatively high temperatures.

### CROSS REFERENCE TO RELATED APPLICATIONS

This application claims benefit of U.S. Provisional Application No. 63/443,966 filed Feb. 7, 2023, the entire disclosure of which is herein incorporated by reference.

### FIELD OF THE INVENTION

Anion exchange polymers capable of forming anion-exchange membranes (AEMs) and ionomers (AEIs) are provided for use in anion exchange membrane devices including fuel cells (FCs), electrolyzers (ELs) and electrodialyzer. More specifically, hydroxide exchange polymers are provided which are capable of forming hydroxide-exchange membranes (HEMs), and ionomers (HEIs) for use in various applications such as hydroxide exchange membrane fuel cells (HEMFCs) and hydroxide exchange membrane electrolyzers (HEMEL).

### BACKGROUND OF THE INVENTION

Both proton exchange membrane fuel cells (PEMFCs), a clean and efficient technology of providing power, and proton exchange membrane electrolyzers (PEMELs), a clean and efficient way of producing green hydrogen, have major challenges from the high cost and unsatisfactory durability of catalysts for large-scale commercialization. Borup et al., Chem Rev 2007, 107, 3904. By switching the polymer electrolyte from an “acidic” condition to a “basic” one, HEMFCs and HEMEL are able to work with non-precious metal catalysts and the catalysts are expected to be more durable. Other cheaper components are also possible such as metal bipolar plates. Varcoe, et al., Fuel Cells 2005, 5, 187; Gu et al., Angew Chem Int Edit 2009, 48, 6499; Gu et al., Chem Commun. 2013, 49, 131. However, currently available HEMFCs and HEMEL exhibit insufficient long-term stability due to low interfacial integrity of the electrode membrane assembly (MEA) that comprised of electrocatalyst, HEI and HEM.

The biggest challenge for HEMFCs and HEMELs at present is achieving a chemically and physically stable MEA, where the HEM and HEI are resistant to the hydroxide attack and the MEA maintains a stable morphology under the operational conditions for tens of thousands of hours. Chemical cross-linking and hot pressing are two efficient approaches to enhance the morphological and performance durability of FCs and ELs. S. Srinivasan, et al., J. Electrochem. Soc. 1988, 135, 2209; Jong Hyun Jang, et al., Journal of Power Sources, 2017, 347, 283. The chemical cross-linking is achieved via a reaction between a crosslinking reagent and a cross-linkable polymer to covalently bond the polymer chains and to form a continuous and physically robust polymer network. The hot pressing is achieved by a physical approach where the polymer chains of physically separated membranes are reorganized with heat and pressure to form one homogenous and continuous polymer network.

### SUMMARY OF THE INVENTION

First and second aspects of the invention are directed to an anion exchange polymer which comprises structural units of formulae 1A, optionally 1C and optionally 1D (first aspect); or structural units of formulae 1A, 1B, optionally 1C and optionally 1D (second aspect). A sum of the mole fractions of the structural unit of Formula 1B, 1C and 1D to the mole fractions of formula 1A is from 0 to 100. Formulae 1A, 1B, 1C and 1D have the structures:

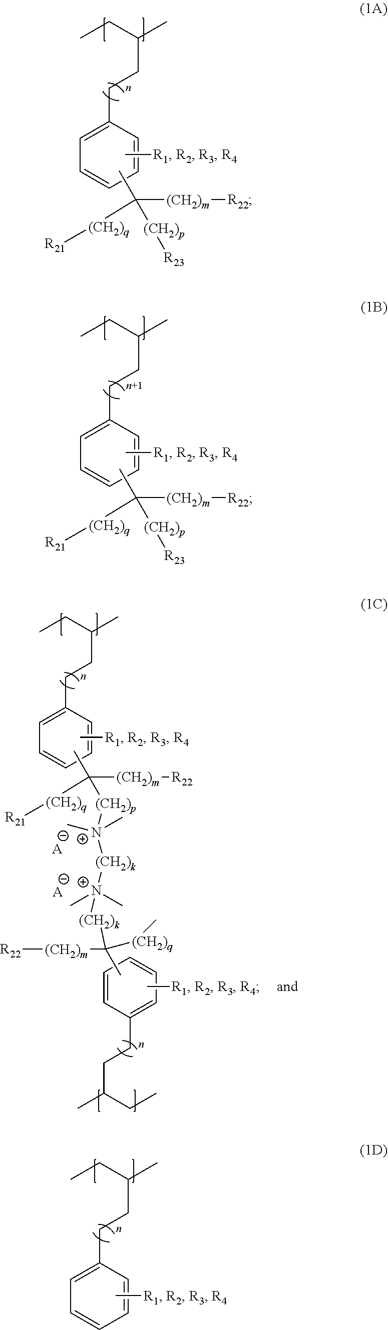

wherein:
   R₁, R₂, R₃, and R₄ are each independently hydrogen, halide, alkyl, alkenyl, alkynyl or aryl, and the alkyl, alkenyl, alkynyl or aryl are optionally substituted with halide;
   each R₂₁ is independently a nitrogen-containing heterocyclic group, or a quaternary ammonium or phosphonium group having the formula (1S):

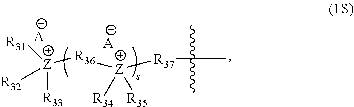

the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
   R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
   R₃₁, R₃₂, R₃₃, R₃₄ and R₃₅ are each independently alkyl, alkenyl, alkynyl or aryl;
   R₃₆ and R₃₇ are each independently alkylene;
   k, m, n, p, q, and s are each independently an integer from 0 to 20;
   A⁻ is an anion; and
   Z is N or P.

A first haloalkylated polymer is provided which comprises a second reaction product of a second polymerization mixture comprising an intermediate polymer and a haloalkylating reagent having the formula (2S):

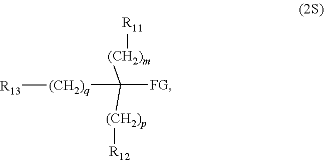

wherein the intermediate polymer comprises a first reaction product of a first polymerization mixture comprising
   (i) a phenyl-substituted alkene monomer having the formula:

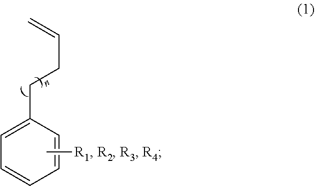

and
(ii) optionally, a second phenyl-substituted alkene monomer having the formula;

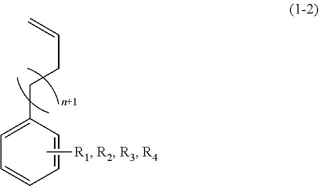

wherein:
   R₁, R₂, R₃ and R₄ are each independently hydrogen, halide, alkyl, alkenyl, alkynyl or aryl, and the alkyl, alkenyl, alkynyl or aryl are optionally substituted with halide;
   each FG is independently hydroxyl, alkenyl, alkynyl or aryl, and the alkenyl, alkynyl or aryl are optionally substituted with halide;
   each R₁₁ is independently halide or substituent (3S)

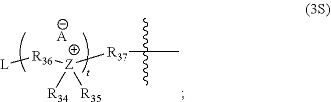

R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
L is halide;
m, n, p, q and t are each independently an integer from 0 to 20; and
Z is N or P.

A third and fourth aspect of the invention is directed to an anion exchange polymer comprising structural units of formulae 1A, 2A, optionally 1C, optionally 1D and optionally 3A (third aspect); or structural units of formulae 1A, 3A, optionally 1C and optionally 1D (fourth aspect). A sum of the mole fractions of the structural unit of Formula 2A, 1C, 1D and 3A to the mole fraction of Formula 1A in the polymer is from 0.01 to 100, wherein the structural units of formulae 1A, 1C, 1D, 2A and 3A are:

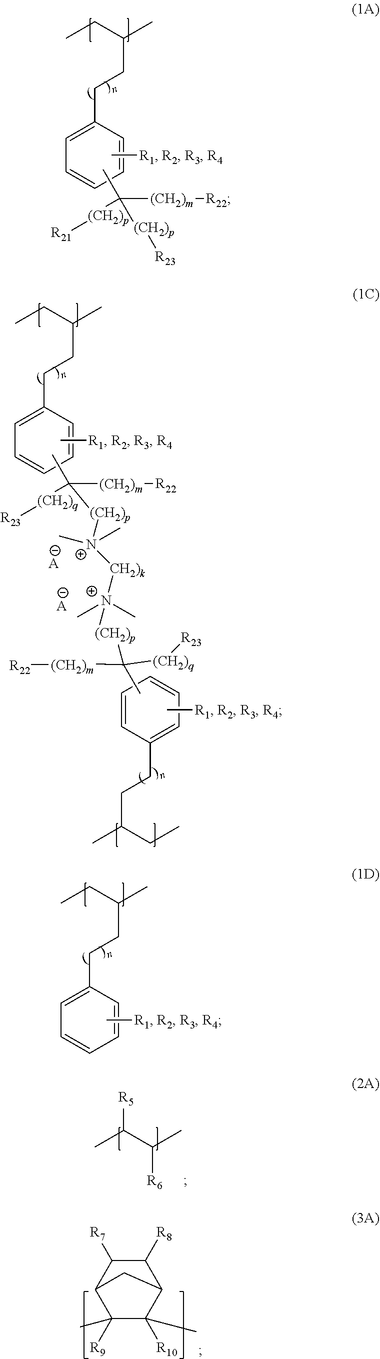

wherein:
   R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or R₇ and R₈ are optionally linked to form a 4-, 5-, 6- or 7-membered ring optionally substituted with halide or alkyl, or to form a bicyclic compound optionally substituted with halide;
   R₅ and R₆ are each independently hydrogen, halide, alkyl, alkenyl or alkynyl and the alkyl, alkenyl or alkynyl are optionally substituted with halide, or R₅ and R₆ are optionally linked to form a 4-, 5-, 6- or 7-membered ring optionally substituted with halide or alkyl;
   each R₂₁ is independently a nitrogen-containing heterocyclic group or a quaternary ammonium or phosphonium group having the formula (1S),

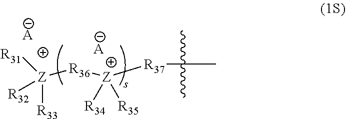

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
   R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
   R₃₁, R₃₂, R₃₃, R₃₄ and R₃₅ are each independently alkyl, alkenyl, alkynyl or aryl;
   R₃₆ and R₃₇ are each independently alkylene;
   A⁻ is an anion;
   k, m, n, p, q and s are each independently an integer from 0 to 20; and
   Z is N or P.

A second haloalkylated polymer is provided which comprises a second reaction product of a second polymerization mixture comprising an intermediate polymer and a haloalkylating reagent having formula (2S):

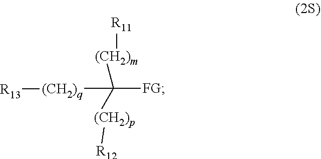

wherein the intermediate polymer comprises a first reaction product of a first polymerization mixture comprising either:
   (i) a phenyl-substituted alkene monomer having formula (1), an alkene monomer having formula (2); and optionally, a norbornene monomer or derivative thereof having formula (3); or
   (ii) the phenyl-substituted alkene monomer having formula (1), the norbornene monomer or derivative thereof having formula (3), and optionally, the alkene monomer having formula (2);
wherein:
   the phenyl-substituted alkene monomer having formula (1) is:

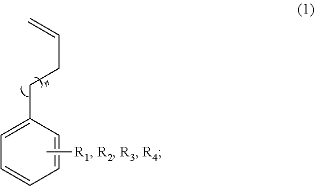

the alkene monomer having formula (2) is:

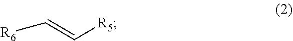

the norbornene monomer or derivative thereof having formula (3) is:

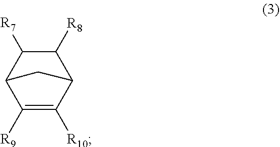

R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or wherein R₇ and R₈ are optionally linked to form a 4-, 5-, 6- or 7-membered ring optionally substituted with halide or alkyl or to form a bicyclic compound optionally substituted with halide;
R₅ and R₆ are each independently hydrogen, halide, alkyl, alkenyl or alkynyl and the alkyl, alkenyl or alkynyl are optionally substituted with halide, or wherein R₅ and R₆ are optionally linked to form a 4-, 5-, 6- or 7-membered ring optionally substituted with halide or alkyl;
each Ru 1 is independently halide or substituent (3S):

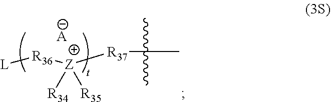

R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
each FG is independently hydroxyl, alkenyl, alkynyl or aryl, and the alkenyl, alkynyl or aryl are optionally substituted with halide;
L is halide;
m, n, p, q and t are each independently an integer from 0 to 20; and
Z is N or P.

In the first through fourth aspects of the invention, a polymer is provided which comprises a reaction product of a mixture comprising (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3). This polymer is referred to herein as a phenyl-substituted polyolefin.

A polymer is provided which comprises a reaction product of a mixture comprising a haloalkylating reagent and the phenyl-substituted polyolefin. This polymer is referred to herein as a haloalkylated polymer.

A polymer is provided which comprises a reaction product of a mixture comprising a quaternization reagent and the haloalkylated polymer. This polymer is referred to herein as an anion exchange polymer.

A polymer is provided which comprises a reaction product of a hydroxide solution and the anion exchange polymer. This polymer is referred to herein as a hydroxide exchange polymer.

A method of making a non-crosslinked anion exchange polymer is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting the haloalkylated polymer with the quaternization reagent to form an anion exchange polymer; and
exchanging anions of the anion exchange polymer with halide, hydroxide, bicarbonate, or carbonate ions or any combination thereof to form the non-crosslinked anion exchange polymer.

Another method of making a crosslinked anion exchange polymer is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting partially the haloalkylated polymer with the quaternization reagent to form the crosslinkable anion exchange polymer;
reacting the crosslinkable anion exchange polymer with a crosslinking reagent to form a crosslinked anion exchange polymer; and
exchanging anions of the crosslinked anion exchange polymer with halide, hydroxide, bicarbonate, or carbonate ions or any combination thereof to form the crosslinked anion exchange polymer.

Yet another method of making a non-crosslinked anion exchange polymer membrane is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting the haloalkylated polymer with the quaternization reagent to form an anion exchange polymer;
exchanging anions of the anion exchange polymer with halide, hydroxide, bicarbonate, or carbonate ions or any combination thereof to form the non-crosslinked anion exchange polymer;
dissolving the non-crosslinked anion exchange polymer in a solvent to form a polymer suspension or solution; and
casting the polymer suspension or solution to form the non-crosslinked anion exchange polymer membrane.

A method of making a crosslinked anion exchange polymer membrane is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin polymer with the haloalkylating agent to form the haloalkylated polymer;
reacting partially the haloalkylated polymer with the quaternization reagent to form a crosslinkable anion exchange polymer;
exchanging anions of the crosslinkable anion exchange polymer with halide, hydroxide, bicarbonate, or carbonate ions or any combination thereof to form the crosslinked anion exchange polymer;
dissolving the crosslinked anion exchange polymer in a solvent to form a suspension or solution; and
casting the polymer suspension or solution with an addition of a crosslinking reagent to form a crosslinked ion exchange membrane.

A method of making a hot-pressed electrode is provided, the method comprising:
mixing an electrocatalyst with an anion exchange polymer solution comprising an anion exchange polymer as described herein to form an electrode ink;
coating the electrode ink onto a substrate comprising carbon paper to form an electrode;
drying the electrode; and
applying pressure on the dried electrode at a temperature ranging from 70 to 200° C. to form a hot-pressed electrode.

A method of making a hot-pressed membrane electrode assembly is provided, the method comprising:
mixing an electrocatalyst with an anion exchange polymer solution comprising an anion exchange polymer as described herein to form an electrode ink;
coating the electrode ink onto a substrate comprising carbon paper to form an electrode;
drying the electrode;
applying pressure on the dried electrode at a temperature ranging from 70 to 200° C. to form a hot-pressed electrode;
sandwiching an anion exchange membrane with the hot-pressed electrode to form the hot-pressed membrane electrode assembly; and
optionally, applying pressure on the hot-pressed membrane electrode assembly at a temperature ranging from 70 to 200° C. to finish the assembly.

Another method of making a hot-pressed membrane electrode assembly is provided, the method comprising:
mixing an electrocatalyst with an anion exchange polymer solution comprising an anion exchange polymer as described herein to form an electrode ink;
coating the electrode ink onto a substrate comprising an anion exchange membrane to form an electrode membrane assembly;
drying the electrode membrane assembly; and
applying pressure on the dried electrode membrane assembly at a temperature ranging from 70 to 200° C. to form a hot-pressed electrode membrane assembly.

A method of making a hot-pressed and crosslinked electrode is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink;
coating the crosslinkable electrode ink onto a substrate comprising carbon paper to form an electrode;
drying the electrode; and
applying pressure on the dried electrode at a temperature ranging from 70 to 200° C. to form the hot-pressed and crosslinked electrode.

Another method of making a hot-pressed and crosslinked membrane electrode assembly is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink;
coating the crosslinkable electrode ink onto a substrate comprising carbon paper to form a crosslinkable electrode;
drying the electrode;
applying pressure on the dried electrode at a temperature ranging from 70 to 200° C. to form a hot-pressed and crosslinked electrode;
sandwiching an anion exchange membrane with the hot-pressed and
crosslinked electrode to form the hot-pressed and crosslinked membrane electrode assembly; and
optionally, applying pressure on the membrane electrode assembly at a temperature ranging from 70 to 200° C. to finish the assembly.

Yet another method of making a hot-pressed and crosslinked electrode membrane electrode assembly is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink,
coating the crosslinkable electrode ink onto a substrate comprising an anion exchange membrane to form a crosslinkable electrode membrane assembly;
drying the crosslinkable electrode membrane assembly; and
applying pressure on the dried crosslinkable electrode membrane assembly at a temperature ranging from 70 to 200° C. to form the hot-pressed and crosslinked electrode membrane assembly.

An anion exchange membrane is also provided, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the anion exchange membrane comprising an anion exchange polymer as described herein.

An anion exchange membrane fuel cell, electrolyzer, electrodialyzer, solar hydrogen generator, flow battery, desalinator, sensor, demineralizer, water purifier, waste water treatment system, ion exchanger, or CO₂ separator is also provided, the fuel cell, electrolyzer, electrodialyzer, solar hydrogen generator, flow battery, desalinator, sensor, demineralizer, water purifier, waste water treatment system, ion exchanger, or CO₂ separator comprising an anion exchange polymer as described herein.

Also provided is a reinforced electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator. The membrane comprises a porous substrate impregnated with an anion exchange polymer as described herein.

Other objects and features will be in part apparent and in part pointed out hereinafter.

### BRIEF DESCRIPTION OF THE DRAWINGS

FIG. 1A illustrates an exemplary hydroxide exchange membrane fuel cell.

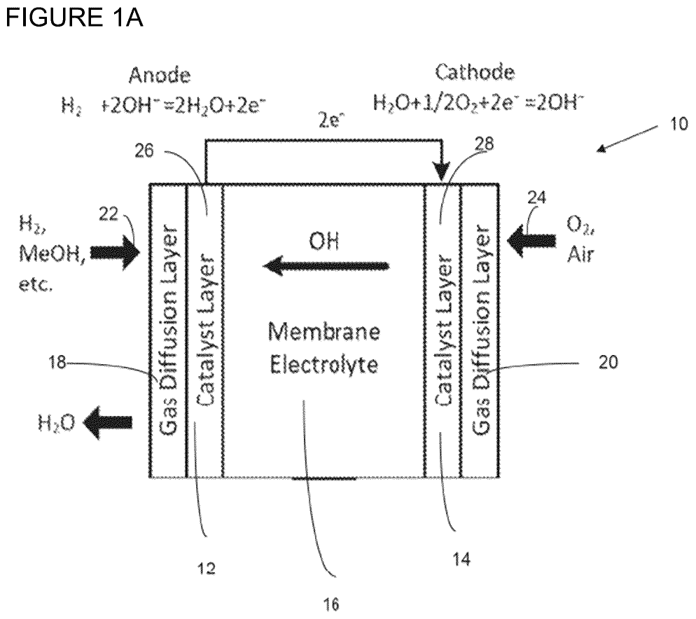

FIG. 1B illustrates an exemplary hydroxide exchange membrane electrolyzer.

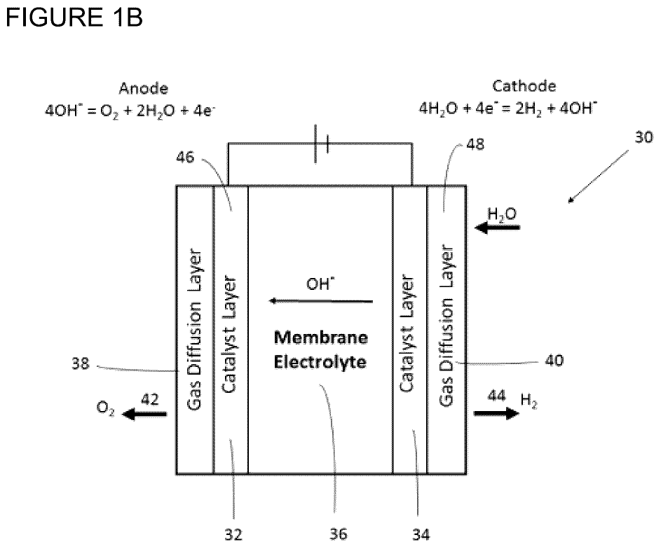

FIG. 2 depicts an 1HNMR spectrum of P-1-Ph-Br-0.72 in CDCl3

FIG. 3 depicts an 1H NMR spectrum of P-1-Ph-TMA-0.72 in DMSO-d6.

FIG. 4 depicts a hot-pressed membrane.

### DESCRIPTION OF THE PREFERRED EMBODIMENTS

HEMs/HEIs formed from poly(aryl alkylene) polymers with various pendant cationic groups and having intrinsic hydroxide conduction channels have been discovered which simultaneously provide improved chemical stability, conductivity, water uptake, good solubility in selected solvents, mechanical properties, and other attributes relevant to HEM/HEI performance. HEMs/HEIs formed from these polymers exhibit superior chemical stability, anion conductivity, decreased water uptake, good solubility in selected solvents, and improved mechanical properties in an ambient dry state as compared to conventional HEM/HEIs. The inventive HEMFCs exhibit enhanced performance and durability at relatively high temperatures.

Herein, a series of novel anion exchange polymers having an aliphatic backbone were prepared. The glass transition temperature (Tg), ion exchange capacity, mechanical strength and conductivity of the resulting membrane can be fine-tuned with the ratio of the selected monomers and the degree of functionalization. Both crosslinked and non-crosslinked HEMs/HEIs based on these novel anion exchange polymers showed high alkaline stability and good conductivity. Upon hot pressing, these anion exchange polymers can re-organize its polymer network to form a homogenous polymer membrane that help improve the long-term durability and performance of electrochemical devices such as fuel cells and electrolyzers.

First and second aspects of the invention are directed to an anion exchange polymer which comprises structural units of formulae 1A, optionally 1C and optionally 1D (first aspect); or structural units of formulae 1A, 1B, optionally 1C and optionally 1D (second aspect). A sum of the mole fractions of the structural unit of Formula 1B, 1C and 1D to the mole fractions of formula 1A is from 0 to 100. Formulae 1A, 1B, 1C, and 1D have the structures:

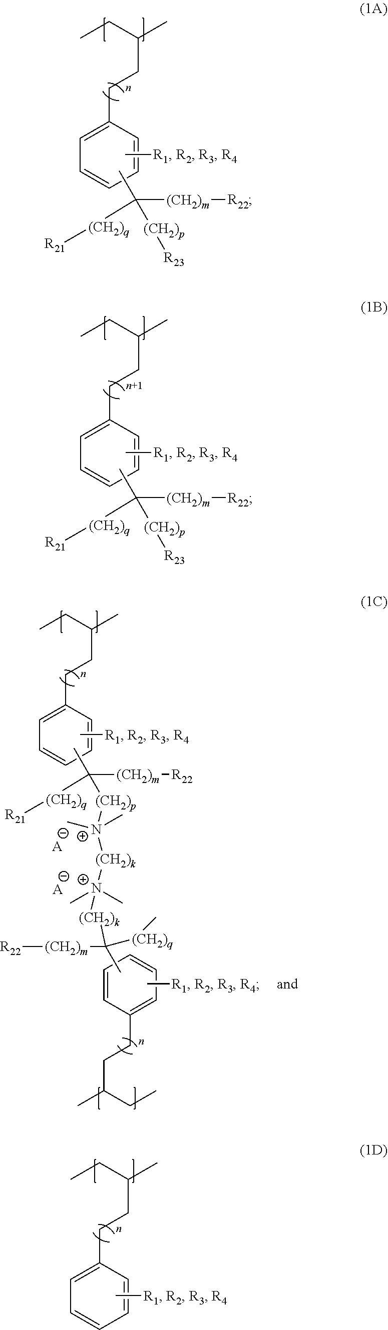

wherein:
   R₁, R₂, R₃, and R₄ are each independently hydrogen, halide, alkyl, alkenyl, alkynyl or aryl, and the alkyl, alkenyl, alkynyl or aryl are optionally substituted with halide;
   each R₂₁ is independently a nitrogen-containing heterocyclic group, or a quaternary ammonium or phosphonium group having the formula (1S):

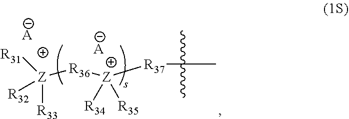

the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
   R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
   R₃₁, R₃₂, R₃₃, R₃₄ and R₃₅ are each independently alkyl, alkenyl, alkynyl or aryl;
   R₃₆ and R₃₇ are each independently alkylene;
   k, m, n, p, q, and s are each independently an integer from 0 to 20;
   A⁻ is an anion; and
   Z is N or P.

In the first aspect, the polymer can comprise any one of the following combinations: the structural units of formulae 1A; 1A and 1C; 1A and 1D; or 1A, 1C and 1D.

In the second aspect, the polymer can comprise any one of the following combinations: the structural units of formulae 1A and 1B; 1A, 1B and 1C; 1A, 1B and 1D; or 1A, 1B, 1C and 1D.

In the first and second aspects of the invention, the sum of the mole fractions of the structural unit of Formula 1B, 1C and 1D to the mole fractions of formula 1A can be from 0.1 to 10.

A functionalized polymer including structural units of the formula (1A) or (1B) can be made by introducing a haloalkylated substituent on the phenyl ring of a polymer including structural units of formula (1D) or prepared from a polymerization mixture comprising the monomer (1) and/or (1-2).

A first haloalkylated polymer is provided, which comprises a second reaction product of a second polymerization mixture comprising an intermediate polymer and a haloalkylating reagent having the formula (2S):

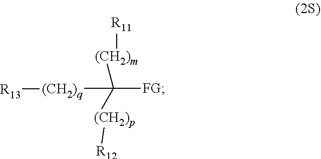

wherein the intermediate polymer comprises a first reaction product of a first polymerization mixture comprising
   (i) a phenyl-substituted alkene monomer having the formula:

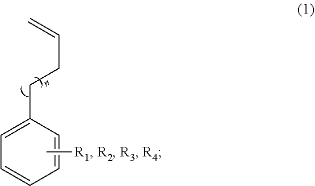

and
(ii) optionally, a second phenyl-substituted alkene monomer having the formula;

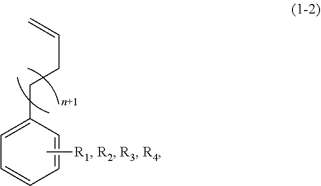

wherein:
   R₁, R₂, R₃ and R₄ are each independently hydrogen, halide, alkyl, alkenyl, alkynyl or aryl, and the alkyl, alkenyl, alkynyl or aryl are optionally substituted with halide;
   each FG is independently hydroxyl, alkenyl, alkynyl or aryl, and the alkenyl, alkynyl or aryl are optionally substituted with halide;
   each Ru 1 is independently halide or substituent (3S):

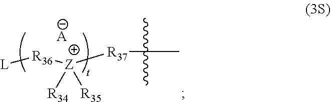

R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
L is halide;
m, n, p, q and t are each independently an integer from 0 to 20; and
Z is N or P.

The intermediate polymer can comprise the monomer (1), or the monomers (1) and (1-2).

A third and fourth aspect of the invention is directed to an anion exchange polymer comprising structural units of formulae 1A, 2A, optionally 1D, optionally 1C and optionally 3A (third aspect); or structural units of formulae 1A, 3A, optionally 1D and optionally 1C (fourth aspect). A sum of the mole fractions of the structural unit of Formula 2A, 1D, 1C and 3A to the mole fraction of Formula 1A in the polymer is from 0.01 to 100, wherein the structural units of Formulae 1A, 2A, 1C, 1D and 3A have the structures:

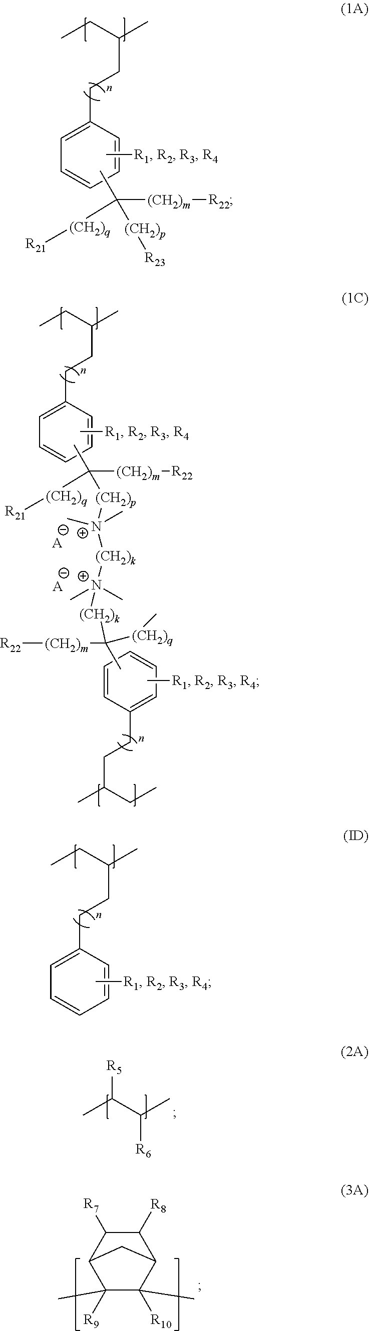

wherein:
   R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or R₇ and R₈ are optionally linked to form a 4-, 5-, 6- or 7-membered ring optionally substituted with halide or alkyl, or to form a bicyclic compound optionally substituted with halide;
   R₅ and R₆ are each independently hydrogen, halide, alkyl, alkenyl or alkynyl and the alkyl, alkenyl or alkynyl are optionally substituted with halide, or R₅ and R₆ are optionally linked to form a 4-, 5-, 6- or 7-membered ring optionally substituted with halide or alkyl;
   each R₂₁ is independently a nitrogen-containing heterocyclic group or a quaternary ammonium or phosphonium group having the formula (1S),

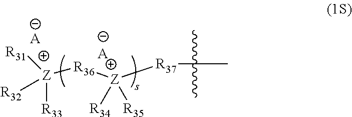

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
   R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
   R₃₁, R₃₂, R₃₃, R₃₄ and R₃₅ are each independently alkyl, alkenyl, alkynyl or aryl;
   R₃₆ and R₃₇ are each independently alkylene;
   A⁻ is an anion;
   k, m, n, p, q and s are each independently an integer from 0 to 20; and
   Z is N or P.

In the third aspect, the polymer can comprise any one of the following combinations: the structural units of formulae 1A and 2A; 1A, 2A and 3A; 1A, 2A and 1C; 1 A, 2A and 1D; 1 A, 2A, 3A and 1C; 1 A, 2A, 3A and 1D; 1 A, 2A, 1C and 1D; or 1 A, 2A, 3A, 1C and 1D.

In the fourth aspect, the polymer can comprise any one of the following combinations: the structural units of formulae 1A and 3A; 1A, 3A and 1C; 1A, 3A and 1D; or 1A, 3A, 1C and 1D.

In the third and fourth aspect of the invention, the sum of the mole fractions of the structural units of Formulae 2A, 1D, 1C and 3A to the mole fraction of the structural unit of Formula 1A in the polymer can be from 0.1 to 10.

A functionalized polymer including structural units of the formula (1A) or (1B) can be made by introducing a haloalkylated substituent on the phenyl ring of a polymer including structural units of formula (1D) or prepared from a polymerization mixture comprising the monomer (1).

A second haloalkylated polymer is provided which comprises a second reaction product of a second polymerization mixture comprising an intermediate polymer and a haloalkylating reagent having formula (2S):

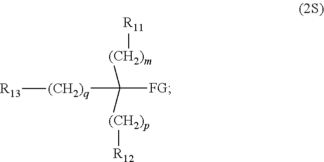

wherein the intermediate polymer comprises a first reaction product of a first polymerization mixture comprising either:
   (i) a phenyl-substituted alkene monomer having formula (1), an alkene monomer having formula (2); and optionally, a norbornene monomer or derivative thereof having formula (3); or
   (ii) the phenyl-substituted alkene monomer having formula (1), the norbornene monomer or derivative thereof having formula (3), and optionally, the alkene monomer having formula (2);
wherein:
   the phenyl-substituted alkene monomer having formula (1) is:

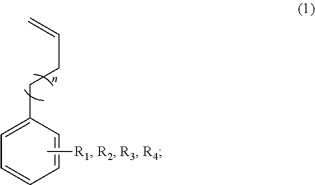

the alkene monomer having formula (2) is:

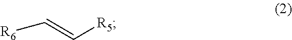

and
the norbornene monomer or derivative thereof having formula (3) is:

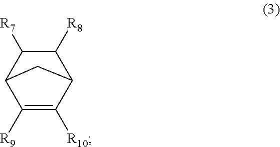

R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or wherein R₇ and R₈ are optionally linked to form a 4-, 5-, 6- or 7-membered ring optionally substituted with halide or alkyl or to form a bicyclic compound optionally substituted with halide;
R₅ and R₆ are each independently hydrogen, halide, alkyl, alkenyl or alkynyl and the alkyl, alkenyl or alkynyl are optionally substituted with halide, or wherein R₅ and R₆ are optionally linked to form a 4-, 5-, 6- or 7-membered ring optionally substituted with halide or alkyl;
each Ru 1 is independently halide or substituent (3S)

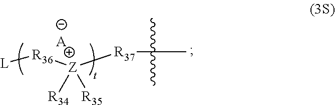

R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
each FG is independently hydroxyl, alkenyl, alkynyl or aryl, and the alkenyl, alkynyl or aryl are optionally substituted with halide;
L is halide;
m, n, p, q and t are each independently an integer from 0 to 20; and
Z is N or P.

The second haloalkylated polymer can comprise any one of the following combinations: the monomers of formulae (1) and (2), or the monomers of formulae (1) and (3), or the monomers of formulae (1), (2) and (3).

The phenyl-substituted alkene monomer has the formula:

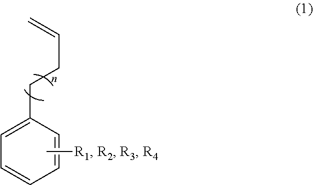

wherein R₁, R₂, R₃ and R₄ are each independently hydrogen, halide, alkyl, alkenyl, alkynyl or aryl, and the alkyl, alkenyl, alkynyl or aryl are optionally substituted with halide; Preferably, Ru, R₂, R₃ and R₄ are each independently hydrogen, halide such as fluorine, or alkyl optionally substituted with halide such as methyl, ethyl, propyl, butyl, pentyl, or hexyl, and n is an integer from 0 to 20.

Preferably, the phenyl-substituted alkene monomer (1) comprises 6-phenyl-1-butene, 5-phenyl-1-butene, 4-phenyl-1-butene, 3-phenyl-1-butene, or any combination thereof.

The second phenyl-substituted alkene monomer has the formula:

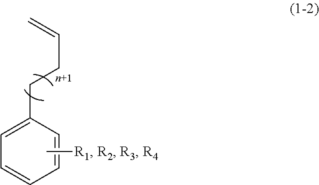

wherein R₁, R₂, R₃ and R₄ and n are as defined for the monomer of formula (1) above.

The alkene monomer has the formula:

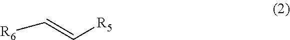

wherein R₅ and R₆ are each independently hydrogen, halide, alkyl, alkenyl or alkynyl and the alkyl, alkenyl or alkynyl are optionally substituted with halide, or R₅ and R₆ are linked to form a 4-, 5-, 6- or 7-membered ring optionally substituted with halide or alkyl. Preferably, the alkene monomer of formula (2) has R₅ and R₆ being hydrogen, alkenyl such as ethenyl, propenyl, butenyl or R₅ and R₆ being alkenyl and linked to form a 5- or 6-membered ring.

The alkene monomer of formula (2) can comprise optionally substituted ethylene, propene, 1-butene, 2-butene, 1,4-butadiene, cyclopentene, cyclohexene, cycloheptene, cyclooctene, cyclopentadiene, 1,4-cyclohexadiene or any combination thereof.

The norbornene monomer or derivative thereof has the formula (3):

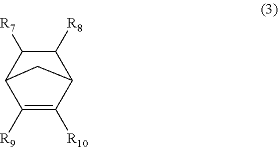

wherein R₇, R₈, R₉, and R₁₀ are each independently hydrogen, halide, alkyl, alkenyl, alkynyl or aryl, and the alkyl, alkenyl, alkynyl or aryl are optionally substituted with halide, or R₇ and R₈ are linked to form a 4-, 5-, 6- or 7-membered ring optionally substituted with halide or alkyl or to form a bicyclic compound optionally substituted with halide. Preferably, the norbornene monomer or derivative thereof of formula (3) has R₇, R₈, R₉ and R₁₀ each independently being hydrogen, alkyl, alkenyl or aryl, or R₇ and R₈ being linked to form a 4-, 5-, 6- or 7-membered ring or to form a bicyclic compound optionally substituted with halide.

Preferably, the norbornene monomer or derivative thereof of formula (3) comprises norbornene or

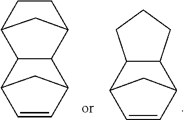

The structural units of formula (1A), (1B), (1C) and (1D) have the formulae:

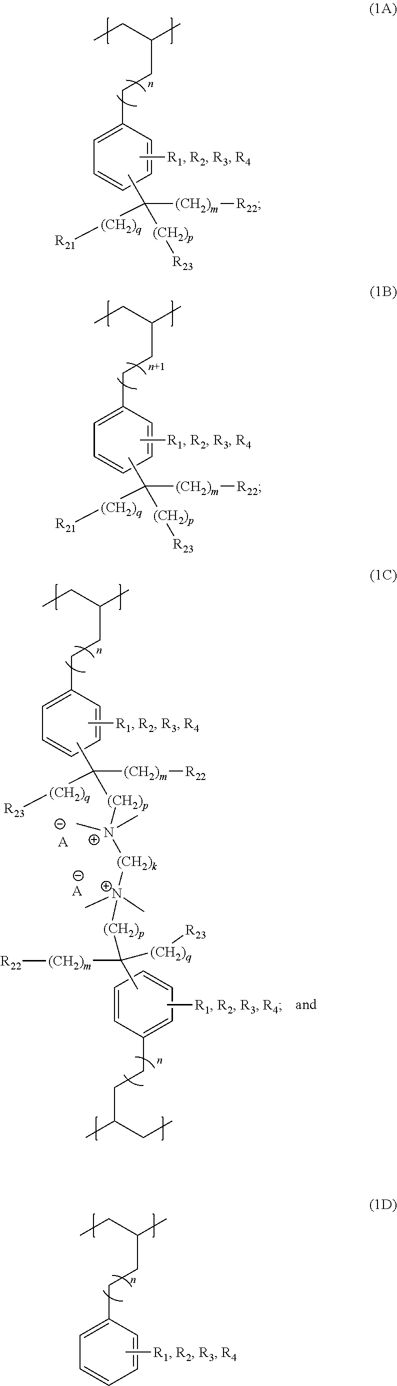

wherein:
   R₁, R₂, R₃ and R₄ are each independently hydrogen, halide, alkyl, alkenyl, alkynyl or aryl, and the alkyl, alkenyl, alkynyl or aryl are optionally substituted with halide;
   each R₂₁ is independently a nitrogen-containing heterocyclic group or a quaternary ammonium or phosphonium group having formula (1S),

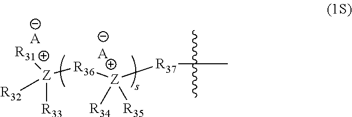

and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
   R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
   R₃₁, R₃₂, R₃₃, R₃₄ and R₃₅ are each independently alkyl, alkenyl, alkynyl or aryl;
   R₃₄ and R₃₅ are each independently alkyl, alkenyl, alkynyl or aryl;
   R₃₆ and R₃₇ are each independently alkylene;
   A− is an anion;
   k, m, n, p, q and s are each independently an integer from 0 to 20; and
   Z is N or P.

In the structural units of formulae (1A), (1B), (1C) and (1D), R₁, R₂, R₃ and R₄ can each independently comprise hydrogen, alkyl, alkenyl, alkynyl, aryl and the alkyl, alkenyl, alkynyl or aryl are optionally substituted with halide. Preferably, R₁, R₂, R₃ and R₄ are each independently hydrogen or alkyl.

In the structural units of formula (1A), (1B) and (1C), R₂₁ can each comprise the nitrogen-containing heterocyclic group; and R₂₂ and R₂₃ can each independently comprise hydrogen or alkyl. Alternatively, R₂₁ can each individually comprise the quaternary ammonium or phosphonium group of the formula (1S); and R₂₂ and R₂₃ are each independently hydrogen or alkyl.

In the quaternary ammonium or phosphonium group of the formula (1S), R₃₁, R₃₂, R₃₃, R₃₄ and R₃₅ can each independently comprise alkyl; R₃₆ and R₃₇ can each independently comprise alkylene; each s can independently comprise an integer from 0 to 4; A⁻ comprises a halide; and Z is N or P.

For example, the quaternary ammonium or phosphonium group having the formula (1S can be:

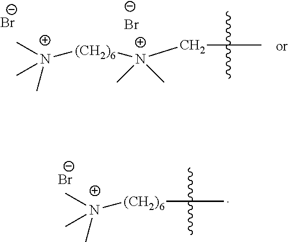

The structural unit of formula (2A) has the structure:

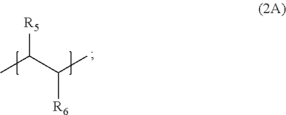

wherein R₅ and R₆ are each independently hydrogen, halide, alkyl, alkenyl or alkynyl and the alkyl, alkenyl or alkynyl are optionally substituted with halide, or R₅ and R₆ are linked to form a 4-, 5-, 6- or 7-membered ring optionally substituted with halide or alkyl. Preferably, R₅ and R₆ are each independently hydrogen, halide, or alkyl and the alkyl is optionally substituted with halide, or R₅ and R₆ are linked to form a 4-, 5-, 6- or 7-membered ring optionally substituted with halide or alkyl. For example, the structural unit of formula (2A) can be:

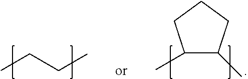

The structural unit of formula (3A) has the structure:

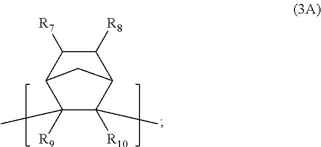

wherein R₇, R₈, R₉, and R₁₀ are each independently hydrogen, halide, alkyl, alkenyl, alkynyl or aryl, and the alkyl, alkenyl, alkynyl or aryl are optionally substituted with halide, or R₇ and R₈ are linked to form a 4-, 5-, 6- or 7-membered ring optionally substituted with halide or alkyl or to form a bicyclic compound optionally substituted with halide. Preferably, R₇, R₈, R₉ and R₁₀ of the structural unit of formula (3A) are each independently hydrogen or alkyl, or R₇ and R₈ are linked to form a 4-, 5-, 6- or 7-membered ring optionally substituted with halide or alkyl or to form a bicyclic compound optionally substituted with halide. For example, the structural unit of formula (3A) can be:

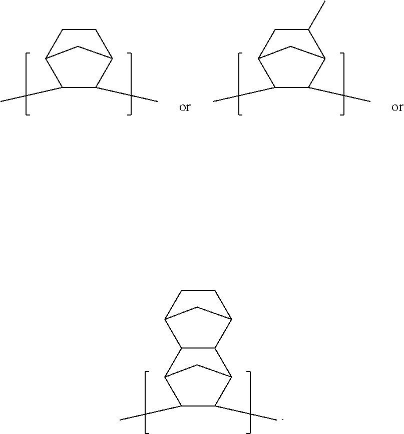

A quaternized polymer is also provided, which can comprise a reaction product of a quaternization reagent and any of the haloalkylated polymers as described herein.

A polymer is also provided, which can comprise a reaction product of an ion exchange solution and the quaternized polymer.

The haloalkylating reagent used to alkylate the polymers described herein (e.g., those including at least the structural unit 1A or 1B), has formula (2S):

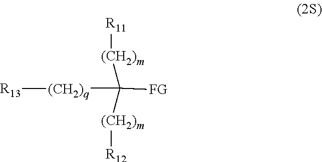

wherein:
   each R₁₁ is independently halide or substituent (3S):

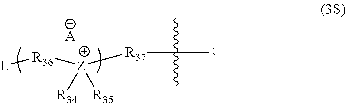

R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
each FG is independently hydroxyl, alkenyl, alkynyl or aryl, and the alkenyl, alkynyl or aryl are optionally substituted with halide;
L is halide;
m, p, q and t are each independently an integer from 0 to 20; and
Z is N or P.

Preferably, the haloalkylating reagent of formula (2S), has each FG being independently hydroxyl or alkenyl; each R₁ 1 being independently halide or the substituent (3S); R₁₂ and R₁₃ being each independently halide, alkyl or the substituent (3S) wherein R₃₄ and R₃₅ are each independently alkyl. For example, the haloalkylating reagent of formula (2S) can be:

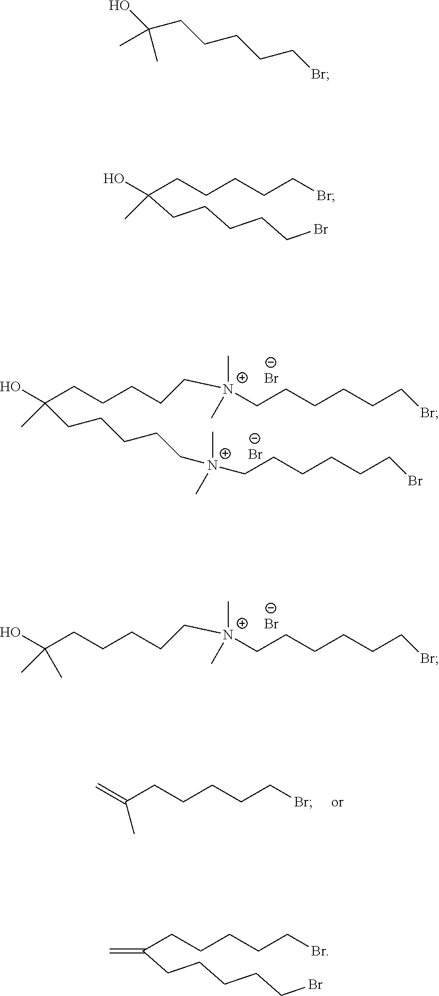

The quaternization reagent, used to quaternize any haloalkylated polymer described herein, can comprise a nitrogen-containing group, a phosphorus-containing group or a quaternary ammonium or phosphonium group having formula (4S):

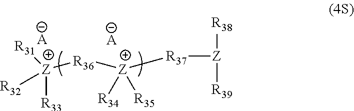

and the nitrogen-containing group being an optionally substituted amine, phosphine, pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₃₁, R₃₂, R₃₃, R₃₄, R₃₅, R₃₈ and R₃₉ are each independently alkyl, alkenyl, alkynyl or aryl;
R₃₆ and R₃₇ are each independently alkylene;
A− is an anion;
L is halide;
s is each independently an integer from 0 to 20; and
Z is N or P.

Preferably, the quaternization reagent is the quaternary ammonium or phosphonium group having formula (4S) wherein R₃₁, R₃₂, R₃₃, R₃₄, R₃₅, R₃₈ and R₃₉ being each independently alkyl; and s being each independently an integer from 0 to 3. For example, the quaternization reagent can be:

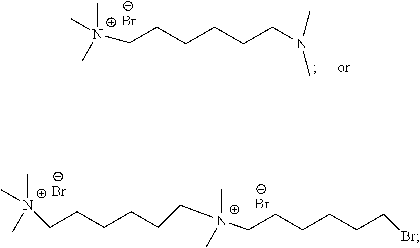

The quaternization reagent can comprise a nitrogen-containing group, such as an imidazole having a formula (4S-1):

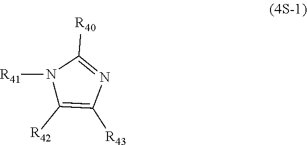

wherein R₄₀, R₄₁, R₄₂ and R₄₃ are each independently hydrogen, alkyl, alkenyl, alkynyl or aryl, and the alkyl, alkenyl, alkynyl or aryl are optionally substituted with halide. Preferably, R₄₀ is 2,4,6-alkylphenyl, and R₄₁, R₄₂ and R₄₃ are each independently C₁-C₆ alkyl. For example, the imidazole compound can comprise formula (4S-2):

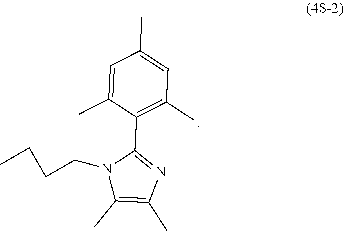 [SMILES: CCCCn1c(-c2c(C)cc(C)cc2C)nc(C)c1C]

In the monomers and structural units defined herein, A⁻ can comprise any anion, including but not limited to, halide such as fluoride, bromide or iodide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, benzoate or any combination thereof.

In the monomers and structural units defined herein, Z can be N. Alternatively, Z can be P.

In the first through fourth aspects of the invention, a polymer is provided which comprises a reaction product of a mixture comprising (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3). This polymer is referred to herein as a phenyl-substituted polyolefin.

A polymer is provided which comprises a reaction product of a mixture comprising a haloalkylating reagent and the phenyl-substituted polyolefin. This polymer is referred to herein as a haloalkylated polymer.

A polymer is provided which comprises a reaction product of a mixture comprising a quaternization reagent and the haloalkylated polymer. This polymer is referred to herein as an anion exchange polymer.

A polymer is provided which comprises a reaction product of a hydroxide solution and the anion exchange polymer. This polymer is referred to herein as a hydroxide exchange polymer.

A method of making a non-crosslinked anion exchange polymer is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting the haloalkylated polymer with the quaternization reagent to form an anion exchange polymer; and
exchanging anions of the anion exchange polymer with halide, hydroxide, bicarbonate, or carbonate ions or any combination thereof to form the non-crosslinked anion exchange polymer.

Another method of making a crosslinked anion exchange polymer is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting partially the haloalkylated polymer with the quaternization reagent to form the crosslinkable anion exchange polymer;
reacting the crosslinkable anion exchange polymer with a crosslinking reagent to form a crosslinked anion exchange polymer; and
exchanging anions of the crosslinked anion exchange polymer with halide, hydroxide, bicarbonate, or carbonate ions or any combination thereof to form the crosslinked anion exchange polymer.

Yet another method of making a non-crosslinked anion exchange polymer membrane is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin with the haloalkylating agent to form the haloalkylated polymer;
reacting the haloalkylated polymer with the quaternization reagent to form an anion exchange polymer;
exchanging anions of the anion exchange polymer with halide, hydroxide, bicarbonate, or carbonate ions or any combination thereof to form the non-crosslinked anion exchange polymer;
dissolving the non-crosslinked anion exchange polymer in a solvent to form a polymer suspension or solution; and
casting the polymer suspension or solution to form the non-crosslinked anion exchange polymer membrane.

A method of making a crosslinked anion exchange polymer membrane is provided, the method comprising:
reacting (i) the phenyl-substituted alkene monomer of formula (1), or (ii) the phenyl-substituted alkene monomer of formula (1) with the second phenyl-substituted alkene monomer of formula (1-2), or (iii) the phenyl-substituted alkene monomer of formula (1) with the alkene monomer of formula (2) and/or the norbornene monomer of formula (3), in the presence of an organic solvent and a polymerization catalyst to form a phenyl-substituted polyolefin;
reacting the phenyl-substituted polyolefin polymer with the haloalkylating agent to form the haloalkylated polymer;
reacting partially the haloalkylated polymer with the quaternization reagent to form a crosslinkable anion exchange polymer;
exchanging anions of the crosslinkable anion exchange polymer with halide, hydroxide, bicarbonate, or carbonate ions or any combination thereof to form the crosslinked anion exchange polymer;
dissolving the crosslinked anion exchange polymer in a solvent to form a suspension or solution; and
casting the polymer suspension or solution with an addition of a crosslinking reagent to form a crosslinked ion exchange membrane.

A method of making a hot-pressed electrode is provided, the method comprising:
mixing an electrocatalyst with an anion exchange polymer solution comprising an anion exchange polymer as described herein to form an electrode ink;
coating the electrode ink onto a substrate comprising carbon paper to form an electrode;
drying the electrode; and
applying pressure on the dried electrode at a temperature ranging from 70 to 200° C. to form a hot-pressed electrode.

A method of making a hot-pressed membrane electrode assembly is provided, the method comprising:
mixing an electrocatalyst with an anion exchange polymer solution comprising an anion exchange polymer as described herein to form an electrode ink;
coating the electrode ink onto a substrate comprising carbon paper to form an electrode;
drying the electrode;
applying pressure on the dried electrode at a temperature ranging from 70 to 200° C. to form a hot-pressed electrode;
sandwiching an anion exchange membrane with the hot-pressed electrode to form the hot-pressed membrane electrode assembly; and
optionally, applying pressure on the hot-pressed membrane electrode assembly at a temperature ranging from 70 to 200° C. to finish the assembly.

Another method of making a hot-pressed membrane electrode assembly is provided, the method comprising:
mixing an electrocatalyst with an anion exchange polymer solution comprising an anion exchange polymer as described herein to form an electrode ink;
coating the electrode ink onto a substrate comprising an anion exchange membrane to form an electrode membrane assembly;
drying the electrode membrane assembly; and
applying pressure on the dried electrode membrane assembly at a temperature ranging from 70 to 200° C. to form a hot-pressed electrode membrane assembly.

A method of making a hot-pressed and crosslinked electrode is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink;
coating the crosslinkable electrode ink onto a substrate comprising carbon paper to form an electrode;
drying the electrode; and
applying pressure on the dried electrode at a temperature ranging from 70 to 200° C. to form the hot-pressed and crosslinked electrode.

Another method of making a hot-pressed and crosslinked membrane electrode assembly is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink;
coating the crosslinkable electrode ink onto a substrate comprising carbon paper to form a crosslinkable electrode;
drying the electrode;
applying pressure on the dried electrode at a temperature ranging from 70 to 200° C. to form a hot-pressed and crosslinked electrode;
sandwiching an anion exchange membrane with the hot-pressed and
crosslinked electrode to form the hot-pressed and crosslinked membrane electrode assembly; and
optionally, applying pressure on the membrane electrode assembly at a temperature ranging from 70 to 200° C. to finish the assembly.

Yet another method of making a hot-pressed and crosslinked electrode membrane electrode assembly is provided, the method comprising:
mixing an electrocatalyst with a crosslinkable anion exchange polymer solution comprising an anion exchange polymer as described herein to form an electrode ink;
mixing a crosslinking reagent and the electrode ink to form a crosslinkable electrode ink,
coating the crosslinkable electrode ink onto a substrate comprising an anion exchange membrane to form a crosslinkable electrode membrane assembly;
drying the crosslinkable electrode membrane assembly; and
applying pressure on the dried crosslinkable electrode membrane assembly at a temperature ranging from 70 to 200° C. to form the hot-pressed and crosslinked electrode membrane assembly.

A crosslinked anion exchange polymer, electrode, membrane electrode assembly or membrane is also provide, which comprises the structural unit having formula (1C) and wherein the anion A comprises a halide, tetrafluoroborate, hexafluorophosphate, bicarbonate, carbonate or hydroxide or any combination thereof.

In the methods described above, the solvent used in forming the phenyl-substituted polyolefin can comprise toluene, benzene, m-xylene, p-xylene, o-xylene, chlorobenzene, 1,2-dichlorobenzene, 1,3-dichlorobenzene, 1,4-dichlorobenzene, dichloromethane, chloroform, nitrobenzene or any combination thereof.

The polymerization catalyst used in forming the phenyl-substituted polyolefin can comprise, for example, TiCl₃·AA/AIEt₂Cl mixture or modified methylaluminoxane (MMAO).

The crosslinking reagent used in forming the crosslinked anion exchange polymer, electrode, membrane electrode assembly or membrane can have the formula:

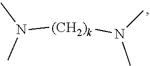

Wherein, k is an integer from 3 to 10. Preferably, the crosslinking reagent comprises N, N,N′,N′-tetramethyl-1,6-hexanediamine, N,N,N′,N′-tetramethyl-1,4-butanediamine, N, N,N′,N′-tetramethyl-1,3-propanediamine, or any combination thereof.

The solvent used to dissolve the anion exchange polymer in any of the methods described above can comprise methanol, ethanol, n-propanol, isopropanol, n-butanol, sec-butanol, tert-butanol, a pentanol, a hexanol, dimethyl sulfoxide, 1-methyl-2-pyrrolidone, dimethylformamide, dimethylacetamide, chloroform, ethyl lactate, tetrahydrofuran, 2-m ethyltetrahydrofuran, water, phenol, acetone, or any combination thereof.

Also provided is an anion exchange membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, comprising any anion exchange polymer described herein.

An anion exchange membrane fuel cell, electrolyzer, electrodialyzer, solar hydrogen generator, flow battery, desalinator, sensor, demineralization of water, ultra-pure water production, wastewater treatment, ion exchanger, or CO₂ separator is provided, which comprises any anion exchange polymer described herein.

A reinforced electrolyte membrane such as a reinforced anion exchange membrane is also provided to increase the mechanical robustness of the anion exchange membrane for stability through numerous wet and dry cycles. The reinforced membrane comprises a porous substrate impregnated with any of the anion exchange polymers as described herein. Methods for preparing reinforced membranes are well known to those of ordinary skill in the art such as those disclosed in U.S. Pat. Nos. RE37.656 and RE37.701, which are incorporated herein by reference for their description of reinforced membrane synthesis and materials.

A reinforced ion exchange membrane can be optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator.

The porous substrate of the reinforced electrolyte membrane comprises a membrane comprised of polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

The porous substrate of the reinforced electrolyte membrane has at least one of the following:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer;
the membrane is prepared by:
wetting the porous substrate in a liquid to form a wetted substrate;
dissolving the polymer in a solvent to form a homogeneous solution or suspension;
applying the solution or suspension onto the wetted substrate to form the reinforced membrane; and
drying the membrane.

The porous substrate can have a thickness from about 1 micron to about 10, 15, 20, 25, 30, 35, 40, 45, 50, 55, 60, 65, 70, 75, 80, 85, 90, 95 or 100 microns. Preferably, the porous substrate has a thickness from about 5 microns to about 30 microns, or from about 7 microns to about 20 microns.

### EXAMPLES

The following non-limiting examples are provided to further illustrate the present invention.

### Example 1

A non-crosslinked phenyl-substituted polyolefin anion exchange membrane (referred to as P-n-Ph-TMA-x, n is an integer from 1 to 20; x is the ratio of phenyl that was functionalized and is from 0 to 1) was prepared from a phenyl-substituted alkene monomer by three major steps: (1) synthesis of a phenyl-substituted polyolefin polymer, P-n-Ph, (2) synthesis of the bromoalkylated polyolefin polymer, P-n-Br-x, (3) synthesis of the quaternized polyolefin polymer, P-n-Ph-TMA-x, and membrane casting and hydroxide ion exchange. The general reaction scheme is depicted below:

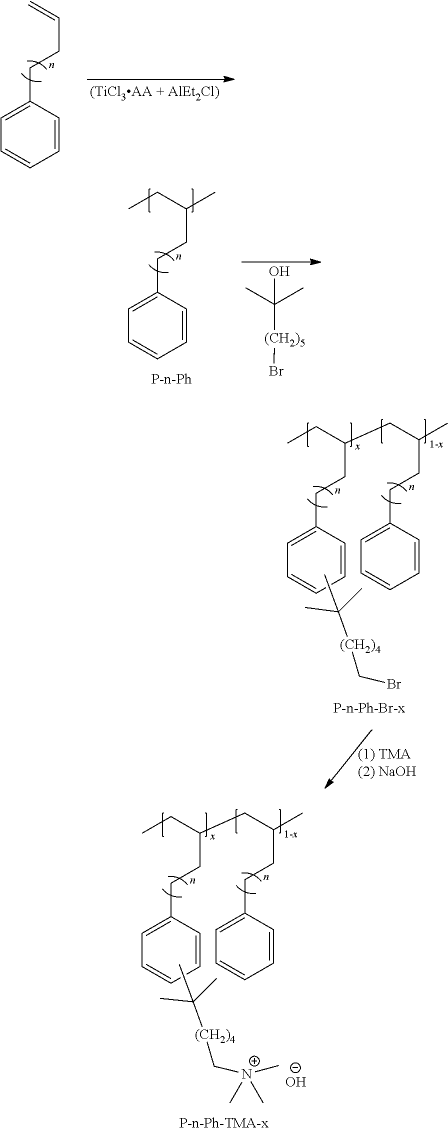

Below is the preparation of phenyl-substituted polyolefin anion exchange polymer/membrane: P-1-Ph-TMA-0.72.

(1) Synthesis of P-1-Ph polymer. 100 mL of toluene was introduced into a 250 mL three-necked flask equipped with an overhead mechanical stirrer and N2 inlet/outlet. The reactor was injected with 25 ml of 4-phenyl-1-butene. 2 g of TiCl3·AA and 25 mL of AlEt2Cl (1.0 M in heptane) were mixed and stirred for 30 min in the glovebox at room temperature to activate the catalyst and subsequently injected into the flask having 4-phenyl-1-butene under rapid stirring to initiate the polymerization reaction. After stirring at 50° C., the polymerization was quenched by methanol and poured into an acidic methanol solution. The produced polymer, P-1-Ph, was washed with methanol several times and then dried in a vacuum oven at 60° C. overnight with a yield of 83%.

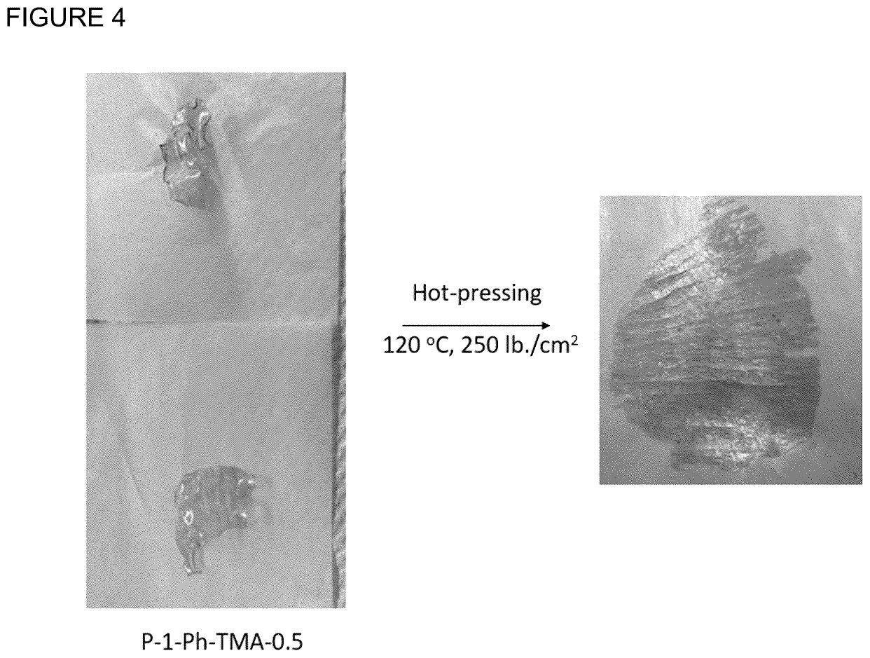

Hot pressing of two pieces of P-1-Ph-TMA-0.5: Two pieces of P-1-Ph-TMA-0.5 was stacked together and then they were pressed by a bench top automatic lab press at a temperature of 120° C. and a pressure of 250 lb./cm² for 2 min. After releasing the pressure and cooling the pressed membrane down to room temperature, the two membranes were fused to one homogenous membrane as shown in FIG. 4. The texture on the hot-pressed membrane was from the metal surfaces that were in contact with the membrane during pressing.

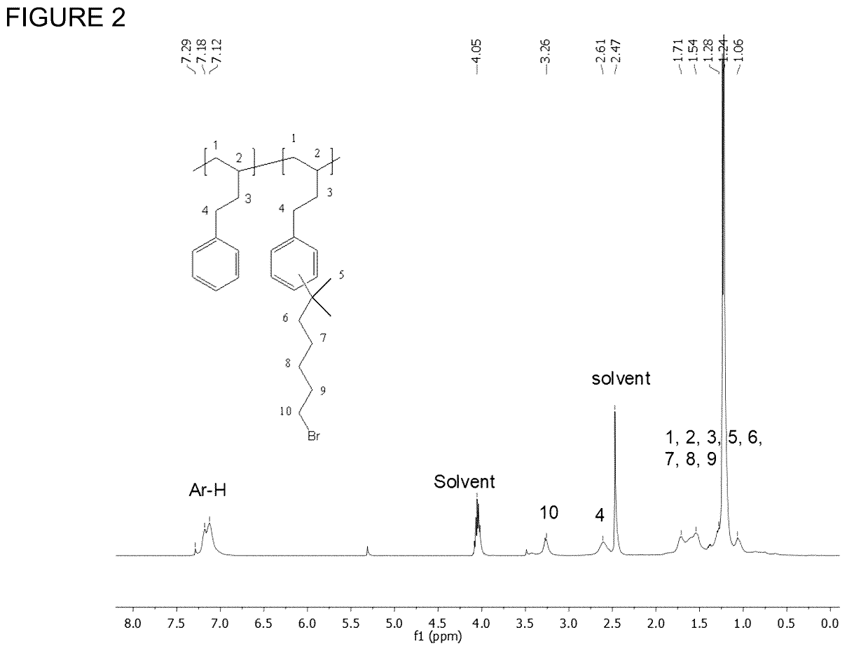

(2) Synthesis of the bromoalkylated polymer, P-1-Ph-Br-0.72: 3 g of P 1-Ph, 4 g of 7-Bromo-2-methylheptan-2-ol, and 60 mL of DCM were introduced into a 250 mL three-necked flask equipped with an overhead mechanical stirrer and N2 inlet/outlet. The mixture was stirred until, P-1-Ph was dissolved. Triflic acid (6 g) was added dropwise slowly at 0° C. The reaction solution was stirred at room temperature for 1 h, after which the solution was poured into methanol to precipitate the polymer. The white product, P-1-Ph-Br-0.72 (72% of the phenyl units in the P-1-Ph were bromoalkylated by 7-Bromo-2-methylheptan-2-ol) was washed with methanol several times and then dried in a vacuum oven at 60° C. overnight with a yield of 95%. ¹HNMR (DMSO-d6; δ, ppm): 7.12-7.29 (Ar_H, the protons on the aromatic rings), 3.26 (H10), 2.61 (H4), 1.06-1.71 (H1, H2, H3, H5, H6, H7, H8, H9) (see FIG. 2).

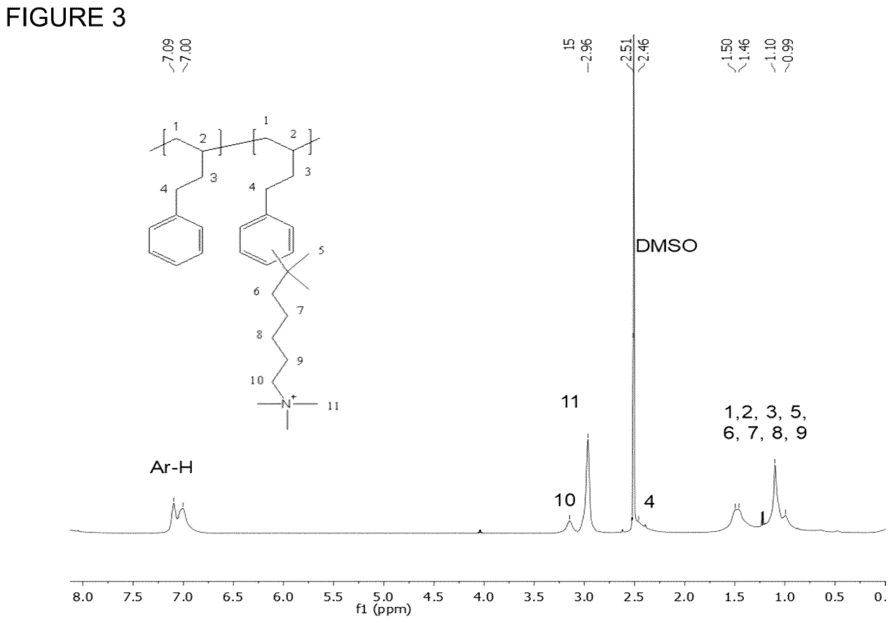

(3) Synthesis of the Quaternized polymer, P-1-Ph-TMA-0.72: To a 50 mL one-necked flask equipped with a magnetic bar, P-1-Ph-Br-0.72 (1.0 g) was dissolved into NMP (10 mL). Trimethylamine (40% in water, 1 mL) was added quickly. The solution was stirred over 24 h at room temperature. The resulting viscous, yellow solution was added dropwise into water. The yellow solid was filtered, washed with water, and dried completely at 60° C. under vacuum. The yield of the polymer, P-1-Ph-TMA-0.72, was almost 100%. ¹HNMR (DMSO-d6; δ, ppm): 7.00-7.09 (Ar_H, the protons on the aromatic rings), 3.15(H10), 2.96 (H11), 2.46 (H4), 0.99-1.50 (H1, H2, H3, H5, H6, H7, H8, H9) (see FIG. 3).

(4) Membrane preparation and ion exchange of P-1-Ph-TMA-0.72: P-1-Ph-TMA-0.72 (1.0 g) was dissolved in NMP (10 ml), and then cast on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

(5) Synthesis of the bromoalkylating reagent 7-Bromo-2-methylheptan-2-ol. Ethyl 6-bromohexanoate (51 ml) and anhydrous diethyl ether (500 mL) were added to a 1 L round-bottom flask in an inert condition. CH₃MgBr solution (3 M in ether, 200 mL) was added dropwise slowly at −15° C. The reaction mixture was stirred at room temperature for 12 h. The reaction was slowly quenched with saturated NH₄Cl(aq.) (200 mL) and water (200 mL). The product was extracted with diethyl ether (3×200 mL), dried over MgSO4, and concentrated on a rotary evaporator. The pure product was isolated as a colorless liquid with a yield of 95%.

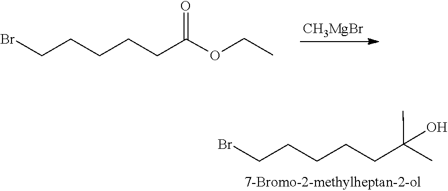

### Example 2

Crosslinked polymer, P-n-Ph-TMA-x(a)-XL, was prepared from P-n-Ph-Br-x polymer by two major steps: (1) synthesis of a partially quaternized polymer, P-n-Ph-TMA-x(a), (x is the ratio of phenyl that was functionalized and is from 0 to 1; a is the ratio of phenyl that has a cation side chain and is from 0 to 1; n is an integer from 0-20), (2) membrane casting with a crosslinking reagent and hydroxide ion exchanging to obtain the crosslinked membrane P-n-Ph-TMA-x(a)-XL. The reaction scheme is depicted below:

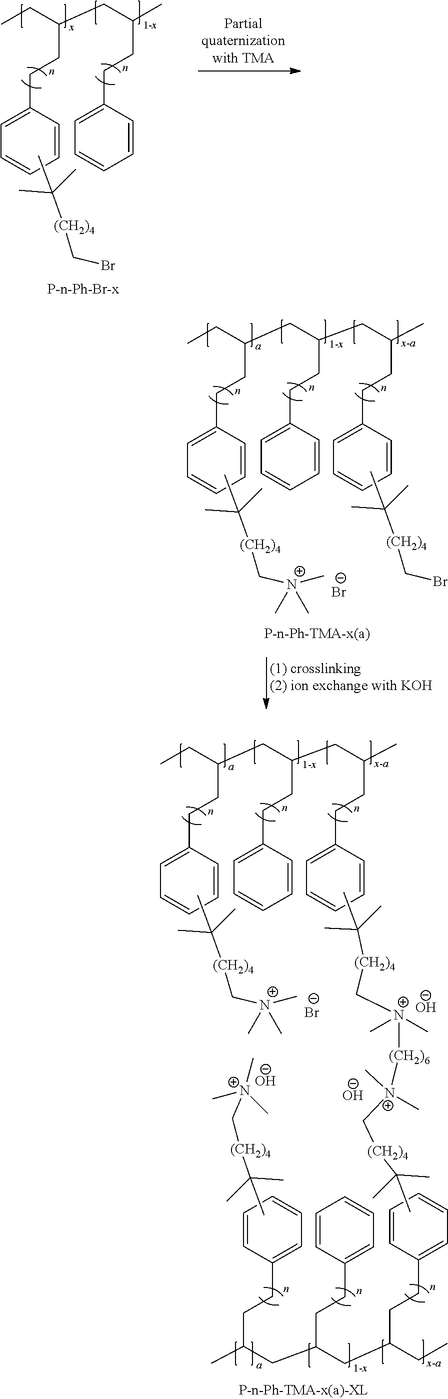

Below is the specific example of the preparation of crosslinked anion exchange membrane/polymer, P-1-Ph-TMA-0.72(0.6)-XL:

(1) Synthesis of the partially quaternized P-1-Ph-TMA-0.72(0.6): To a 50 mL one-necked flask equipped with a magnetic bar, P-1-Ph-Br-0.72 (1.0 g) was dissolved into NMP (10 mL). Trimethylamine (4.2M in ethanol, 0.51 mL) was added quickly. The solution was stirred over 24 h at room temperature. The resulting viscous, yellow solution was added dropwise into water. The yellow solid was filtered, washed with water, and dried completely at 60° C. under vacuum. The yield of the P-1-Ph-TMA-0.72(0.6) was almost 100%.

(2) Crosslinked membrane and ion exchange of the P-1-Ph-TMA-0.72(0.6)-XL: P-1-Ph-TMA-0.72(0.6) (1.0 g) was dissolved in NMP (10 ml), and then N,N,N′,N′-Tetramethyl-1,6-hexanediamine (33 mg) was mixed to the NMP solution, and then the solution was cast on a clear glass plate at 80° C. for 8 hours. The membrane was peeled off from the glass plate in contact with deionized (DI) water. The crosslinked polymer/membrane, P-1-Ph-TMA-0.72(0.6)-XL, in hydroxide form were obtained by ion exchange in 1 M KOH at 60° C. for 24 hours, followed by washing and immersing the membrane in DI water for 48 hours under argon to remove residual KOH.

### Example 3

A non-crosslinked phenyl-substituted polyolefin anion exchange membrane (referred to as P-n-Ph-MQN-x, n is an integer from 1 to 20; x is the ratio of phenyl that was functionalized and is from 0 to 1) was prepared from a bromoalkylated polymer, P-n-Ph-Br-x by (1) quaternization of P-n-Ph-Br-x by MQN small molecule and (2) membrane cast and hydroxide anion exchanging to obtain P-n-Ph-MQN-x. The general reaction scheme is depicted below:

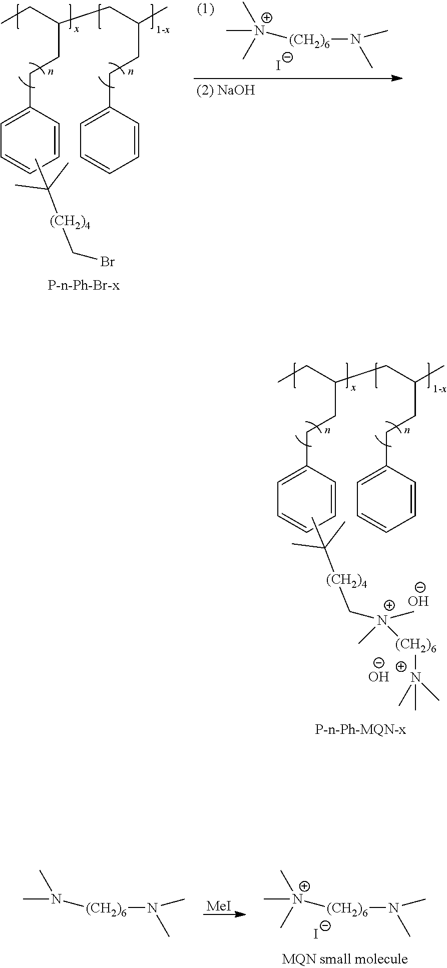

Below is the preparation of phenyl-substituted polyolefin anion exchange polymer/membrane: P-1-Ph-MQN-0.72.

(1) Synthesis of the quaternized polymer, P-1-Ph-MQN-0.72: To a 50 mL one-necked flask equipped with a magnetic bar, P-1-Ph-Br-0.72 (1.0 g) was dissolved into NMP (10 mL). MQN small molecule (805 mg) was added quickly. The solution was stirred over 24 h at room temperature. The resulting viscous, yellow solution was added dropwise into acetone. The yellow solid was filtered, washed with acetone, and dried completely at 60° C. under vacuum. The yield of the polymer, P-1-Ph-MQN-0.72, was 86%.

(2) Membrane preparation and ion exchange of P-1-Ph-MQN-0.72: P-1-Ph-MQN-0.72 (1.0 g) was dissolved in NMP (10 ml), and then cast on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

### Example 4

Crosslinked polymer, P-n-Ph-MQN-x(a)-XL, was prepared from P-n-Ph-Br-x polymer by two major steps: (1) synthesis of a partially quaternized polymer, P-n-Ph-MQN-x(a) (x is the ratio of phenyl that was functionalized and is from 0 to 1; a is the ratio of phenyl that has a cation side chain and is from 0 to 1; n is an integer from 0-20), (2) membrane casting with a crosslinking reagent and hydroxide ion exchanging to obtain the crosslinked polymer/membrane P-n-Ph-MQN-x(a)-XL. The reaction scheme is depicted below.

Below is the specific example of the preparation of crosslinked anion exchange membrane/polymer, P-1-Ph-MQN-0.72(0.6)-XL:

(1) Synthesis of the partially quaternized P-1-Ph-MQN-0.72(0.6): To a 50 mL one-necked flask equipped with a magnetic bar, P-1-Ph-Br-0.72 (1.0 g) was dissolved into NMP (10 mL). MQN (670 mg) was added quickly. The solution was stirred over 24 h at room temperature. The resulting viscous, yellow solution was added dropwise into acetone. The yellow solid was filtered, washed with acetone and dried completely at 60° C. under vacuum. The yield of the P-1-Ph-MQN-0.72(0.6) was 85%.

(2) Crosslinked membrane and ion exchange of the P-1-Ph-MQN-0.72(0.6)-XL: P-1-Ph-MQN-0.72(0.6) (1.0 g) was dissolved in NMP (10 ml), and then N,N,N′,N′-Tetramethyl-1,6-hexanediamine (23 mg) was mixed to the NMP solution, and then the solution was cast on a clear glass plate at 80° C. for 8 hours. The membrane was peeled off from the glass plate in contact with deionized (DI) water. The crosslinked polymer/membrane, P-1-Ph-MQN-0.72(0.6)-XL, in hydroxide form were obtained by ion exchange in 1 M KOH at 60° C. for 24 hours, followed by washing and immersing the membrane in DI water for 48 hours under argon to remove residual KOH.

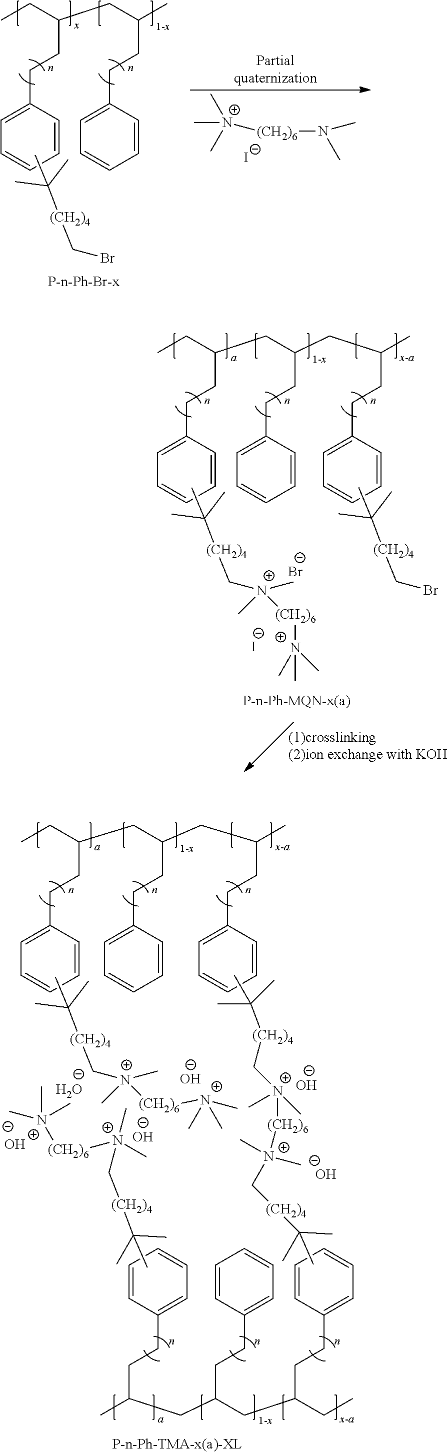

### Example 5

A non-crosslinked phenyl-substituted polyolefin anion exchange membrane (referred to as P-n-Ph-IM-x, n is an integer from 1 to 20; x is the ratio of phenyl that was functionalized and is from 0 to 1) was prepared from a bromoalkylated polymer, P-n-Ph-Br-x by (1) quaternization of P-n-Ph-Br-x by a substituted imidazole (IM) small molecule and (2) membrane cast and hydroxide anion exchanging to obtain P-n-Ph-IM-x. The general reaction scheme is depicted below:

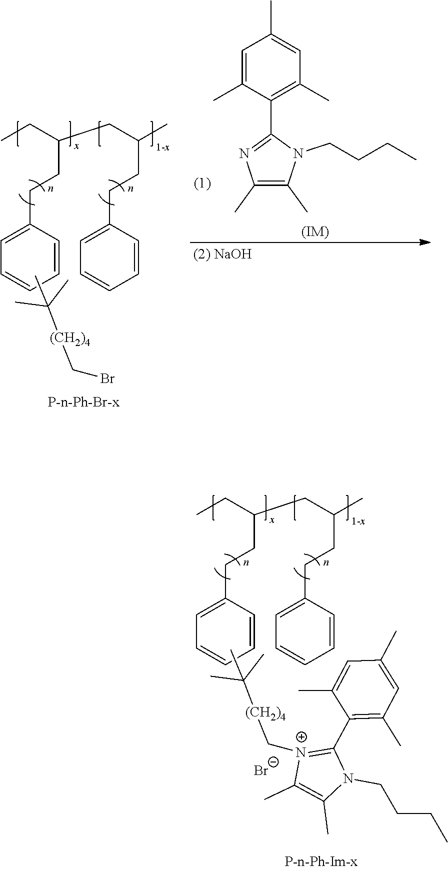

Below is the preparation of phenyl-substituted polyolefin anion exchange polymer/membrane: P-1-Ph-IM-0.72.

(1) Synthesis of the quaternized polymer, P-1-Ph-IM-0.72: To a 50 mL one-necked flask equipped with a magnetic bar, P-1-Ph-Br-0.72 (1.0 g) was dissolved into NMP (10 mL). IM small molecule (694 mg) was added quickly. The solution was stirred over 24 h at room temperature. The resulting viscous, yellow solution was added dropwise into acetone. The yellow solid was filtered, washed with acetone, and dried completely at 60° C. under vacuum. The yield of the polymer, P-1-Ph-IM-0.72, was 86%.

(2) Membrane preparation and ion exchange of P-1-Ph-IM-0.72: P-1-Ph-IM-0.72 (1.0 g) was dissolved in NMP (10 ml), and then cast on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

Synthesis of IM is shown below:

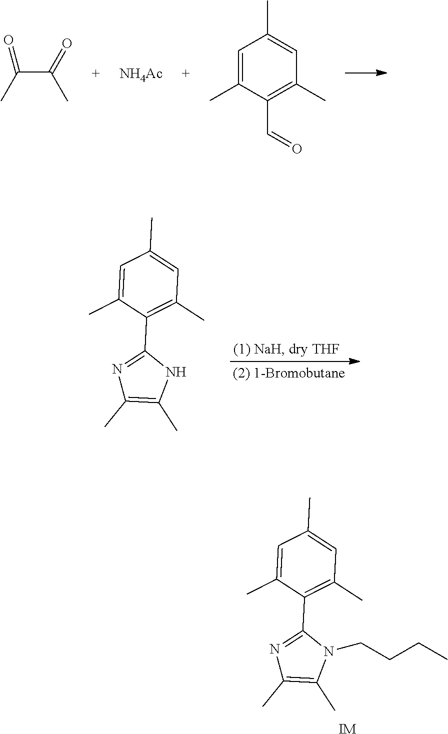

### Example 6

Crosslinked polymer, P-n-Ph-IM-x(a)-XL, was prepared from P-n-Ph-Br-x polymer by two major steps: (1) synthesis of a partially quaternized polymer, P-n-Ph-IM-x(a) (x is the ratio of phenyl that was functionalized and is from 0 to 1; a is the ratio of phenyl that has a cation side chain and is from 0 to 1; n is an integer from 0-20), (2) membrane casting with a crosslinking reagent and hydroxide ion exchanging to obtain the crosslinked polymer/membrane P-n-Ph-IM-x(a)-XL. The reaction scheme is depicted below.

Below is the specific example of the preparation of crosslinked anion exchange membrane/polymer, P-1-Ph-IM-0.72(0.6)-XL:

(1) Synthesis of the partially quaternized P-1-Ph-IM-0.72(0.6): To a 50 mL one-necked flask equipped with a magnetic bar, P-1-Ph-Br-0.72 (1.0 g) was dissolved into NMP (10 mL). IM (781 mg) was added quickly. The solution was stirred over 24 h at room temperature. The resulting viscous, yellow solution was added dropwise into acetone. The yellow solid was filtered, washed with acetone and dried completely at 60° C. under vacuum. The yield of the P-1-Ph-IM-0.72(0.6) was 73%.

(2) Crosslinked membrane and ion exchange of the P-1-Ph-IM-0.72(0.6)-XL: P-1-Ph-IM-0.72(0.6) (1.0 g) was dissolved in NMP (10 ml), and then N,N,N′,N′-Tetramethyl-1,6-hexanediamine (27 mg) was mixed to the NMP solution, and then the solution was cast on a clear glass plate at 80° C. for 8 hours. The membrane was peeled off from the glass plate in contact with deionized (DI) water. The crosslinked polymer/membrane, P-1-Ph-IM-0.72(0.6)-XL, in hydroxide form were obtained by ion exchange in 1 M KOH at 60° C. for 24 hours, followed by washing and immersing the membrane in DI water for 48 hours under argon to remove residual KOH.

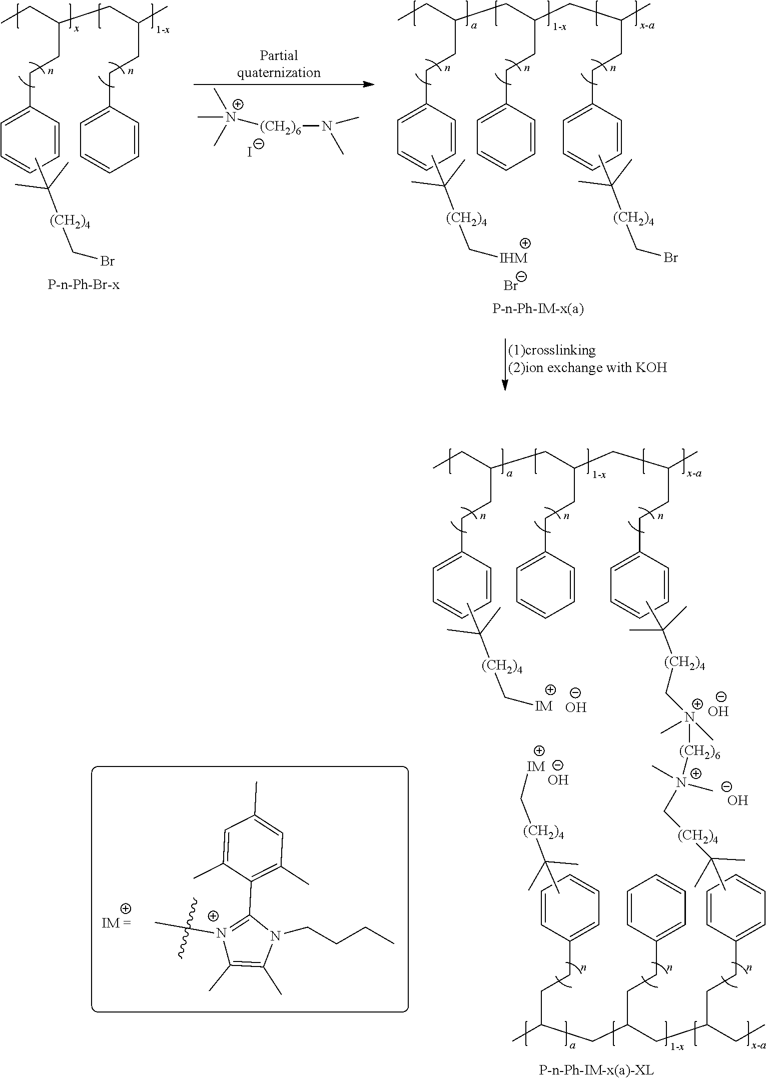

### Example 7

A non-crosslinked copolymer, comprising phenyl-substituted alkene and norbornene monomer, and the anion exchange membrane referred to as P-n-Ph-Nbr-TMA-x(a) (n is an integer from 1 to 20; x is the ratio of phenyl containing repeating unit in the polymer and is from 0 to 1; a is the ratio of the repeating unit having functionalized phenyl and is from 0 to 1) was prepared by three major steps: (1) synthesis of the copolymer, comprising phenyl-substituted alkene and norbornene monomer, P-n-Ph-Nbr-x (2) synthesis of the bromoalkylated polyolefin polymer, P-n-Ph-Nbr-Br (3) synthesis of the quaternized polyolefin polymer, P-n-Ph-Nbr-TMA-x(a), and membrane casting and hydroxide ion exchange. The general reaction scheme is depicted below:

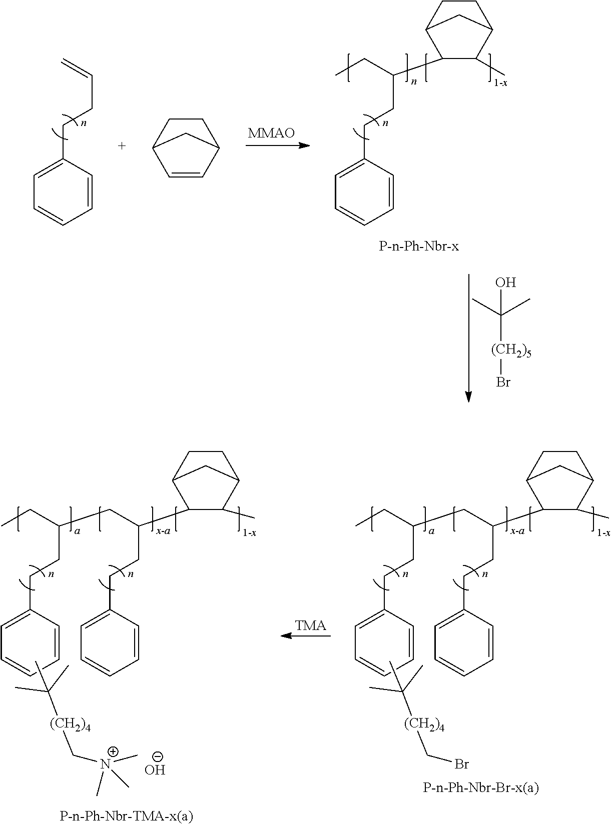

Below is the preparation of phenyl-substituted polyolefin anion exchange polymer/membrane: P-1-Ph-Nbr-TMA-0.85(0.7).

(1) Synthesis of P-1-Ph-Nbr-0.85: 100 mL of toluene was introduced into a 250 mL three-necked flask equipped with an overhead mechanical stirrer and N2 inlet/outlet. 4 mL of MMAO (6.5 wt %, 8.6 mmol) and BHT (0.3M, 2.2 mL, 0.65 mmol) were mixed and stirred for 30 min in a glovebox. Then, to the reactor was injected with 25 ml of 4-phenyl-1-butene (166.7 mmol) and Norbornene (2.73 g, 29.0 mmol). After for 5 hours, the polymerization was quenched by methanol and poured into an acidic methanol solution. The produced polymer, P-1-Ph-Nbr-0.85, was washed with methanol several times and then dried in a vacuum oven at 60° C. overnight.

(2) Synthesis of the bromoalkylated polymer, P-1-Ph-Nbr-Br-0.85(0.7): 1 g of P-1-Ph-Nbr-0.85, 1.16 g of 7-Bromo-2-methylheptan-2-ol, and 20 mL of DCM were introduced into a 50 mL three-necked flask equipped with an overhead mechanical stirrer and N2 inlet/outlet. The mixture was stirred until P-1-Ph-Nbr-0.85 was dissolved. Triflic acid (6 g) was added dropwise slowly at 0° C. The reaction solution was stirred at room temperature for 1 h, after which the solution was poured into methanol to precipitate the polymer. The white product, P-1-Ph-Nbr-Br-0.85(0.7) (70% of the phenyl units in the P-1-Nbr-0.8 were bromoalkylated by 7-Bromo-2-methylheptan-2-ol) was washed with methanol several times and then dried in a vacuum oven at 60° C. overnight with a yield of 91%.

(3) Synthesis of the Quaternized polymer, P-1-Ph-Nbr-TMA-0.85(0.7): To a 50 mL one-necked flask equipped with a magnetic bar, P-1-Ph-Nbr-Br-0.85(0.7) (1.0 g) was dissolved into NMP (10 mL). Trimethylamine (40% in water, 0.7 mL) was added quickly. The solution was stirred over 24 h at room temperature. The resulting viscous, yellow solution was added dropwise into water. The yellow solid was filtered, washed with water, and dried completely at 60° C. under vacuum. The yield of the polymer, P-1-Ph-Nbr-TMA-0.85(0.7), was almost 100%.

(4) Membrane preparation and ion exchange of P-1-Ph-Nbr-TMA-0.85(0.7): P-1-Ph-Nbr-TMA-0.85(0.7) (1.0 g) was dissolved in NMP (10 ml), and then cast on a clear glass plate at 80° C. for 8 hours. The membrane was peeled off from the glass plate in contact with deionized (DI) water. The membrane in hydroxide form were obtained by ion exchange in 1 M KOH at 60° C. for 24 hours, followed by washing and immersing the membrane in DI water for 48 hours under argon to remove residual KOH.

### Example 8

A crosslinked polymer, P-n-Ph-Nbr-TMA-x(a-b)-XL-b (n is an integer from 1 to 20; x is the ratio of phenyl containing repeating unit in the polymer and is from 0 to 1; a is the ratio of the bromoalkylated repeating unit and is from 0 to 1, b is theoretical crosslinking degree), was prepared from P-n-Ph-Nbr-Br-x(a) polymer by two major steps: (1) synthesis of a partially quaternized polymer, P-n-Ph-Nbr-TMA-x(a-b) (2) membrane casting with a crosslinking reagent and hydroxide ion exchanging to obtain the crosslinked membrane P-n-Ph-Nbr-TMA-x(a-b)-XL-b. The reaction scheme is depicted below.

Below is the specific example of the preparation of crosslinked anion exchange membrane/polymer, P-1-Ph-Nbr-TMA-0.85(0.7)-XL:

(1) Synthesis of the partially quaternized P-1-Ph-Nbr-TMA-0.85(0.6)-Br-0.1: To a 50 mL one-necked flask equipped with a magnetic bar, P-1-Ph-Nbr-TMA-0.85(0.7) (1.0 g) was dissolved into NMP (10 mL). Trimethylamine (4.2M in ethanol, 0.76 mL) was added quickly. The solution was stirred over 24 h at room temperature. The resulting viscous, yellow solution was added dropwise into water. The yellow solid was filtered, washed with water, and dried completely at 60° C. under vacuum.

(2) Crosslinked membrane and ion exchange of the P-1-Ph-Nbr-TMA-0.85(0.6)-XL-0.1: P-1-Ph-Nbr-TMA-0.85(0.6)-Br-0.1 (1.0 g) was dissolved in NMP (10 ml), and then N,N,N′,N′-Tetramethyl-1,6-hexanediamine (29 mg) was mixed to the NMP solution, and then the solution was cast on a clear glass plate at 80° C. for 8 hours. The membrane was peeled off from the glass plate in contact with deionized (DI) water. The crosslinked polymer/membrane, P-1-Ph-Nbr-TMA-0.85(0.6)-XL-0.1, in hydroxide form were obtained by ion exchange in 1 M KOH at 60° C. for 24 hours, followed by washing and immersing the membrane in DI water for 48 hours under argon to remove residual KOH.

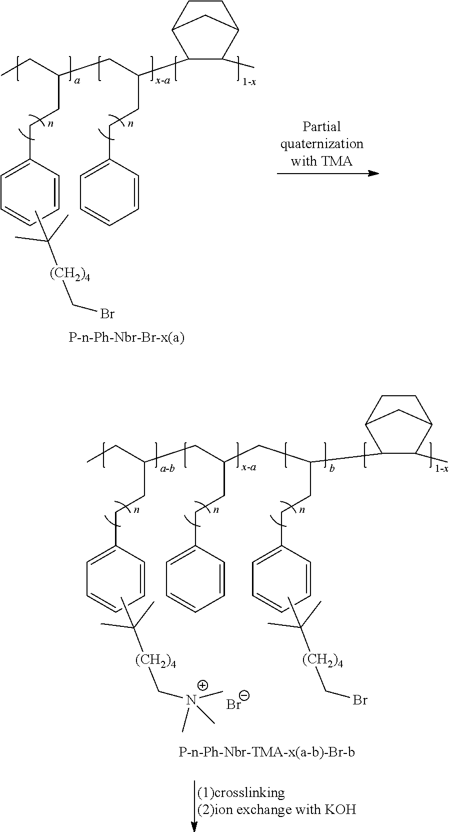

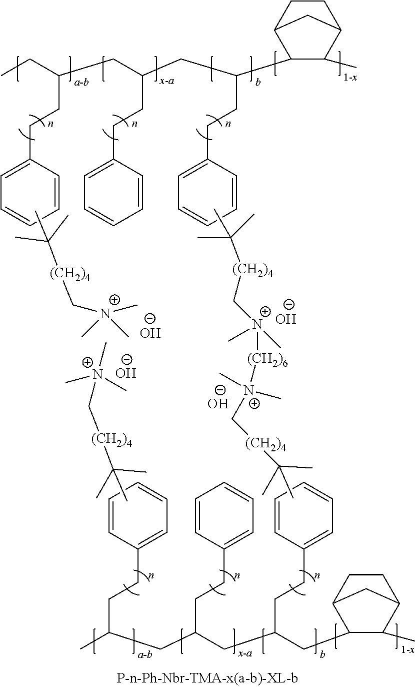

### Example 9

A non-crosslinked anion exchange copolymer/membrane referred to as P-n-Ph-Nbr-MQN-x(a) (n is an integer from 1 to 20; x is the ratio of phenyl containing repeating unit in the polymer and is from 0 to 1; a is the ratio of the repeating unit having functionalized phenyl and is from 0 to 1) was prepared by steps: (1) synthesis of the copolymer, P-n-Ph-Nbr-MQN-x(a), (2) membrane casting and hydroxide ion exchange. The preparation of the polymer/membrane: P-1-Ph-Nbr-MQN-0.85(0.7) is similar to that of Example 7. The general reaction scheme is depicted below:

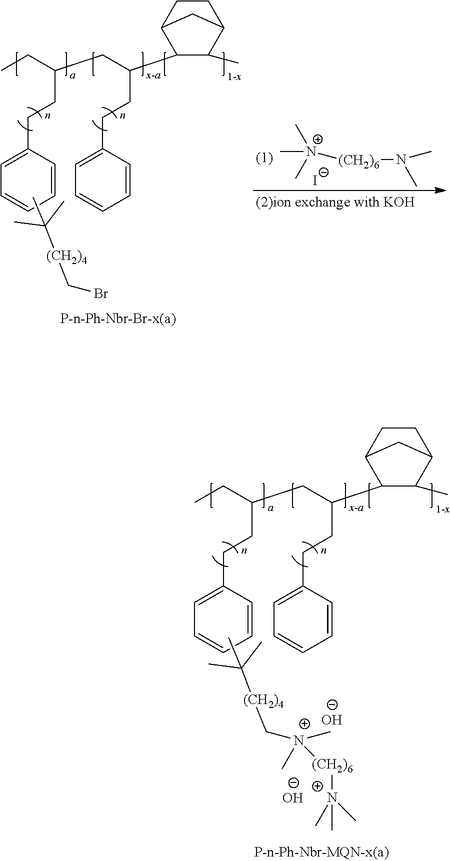

### Example 10

A crosslinked polymer, P-n-Ph-Nbr-MQN-x(a-b)-XL-b (n is an integer from 1 to 20; x is the ratio of phenyl containing repeating unit in the polymer and is from 0 to 1; a is the ratio of the bromoalkylated repeating unit and is from 0 to 1, b is theoretical crosslinking degree), was prepared from P-n-Ph-Nbr-Br-x(a) polymer by two major steps: (1) synthesis of a partially quaternized polymer, P-n-Ph-Nbr-MQN-x(a-b) (2) membrane casting with a crosslinking reagent and hydroxide ion exchanging to obtain the crosslinked membrane P-n-Ph-Nbr-MQN-x(a-b)-XL-b. The reaction scheme is depicted below.

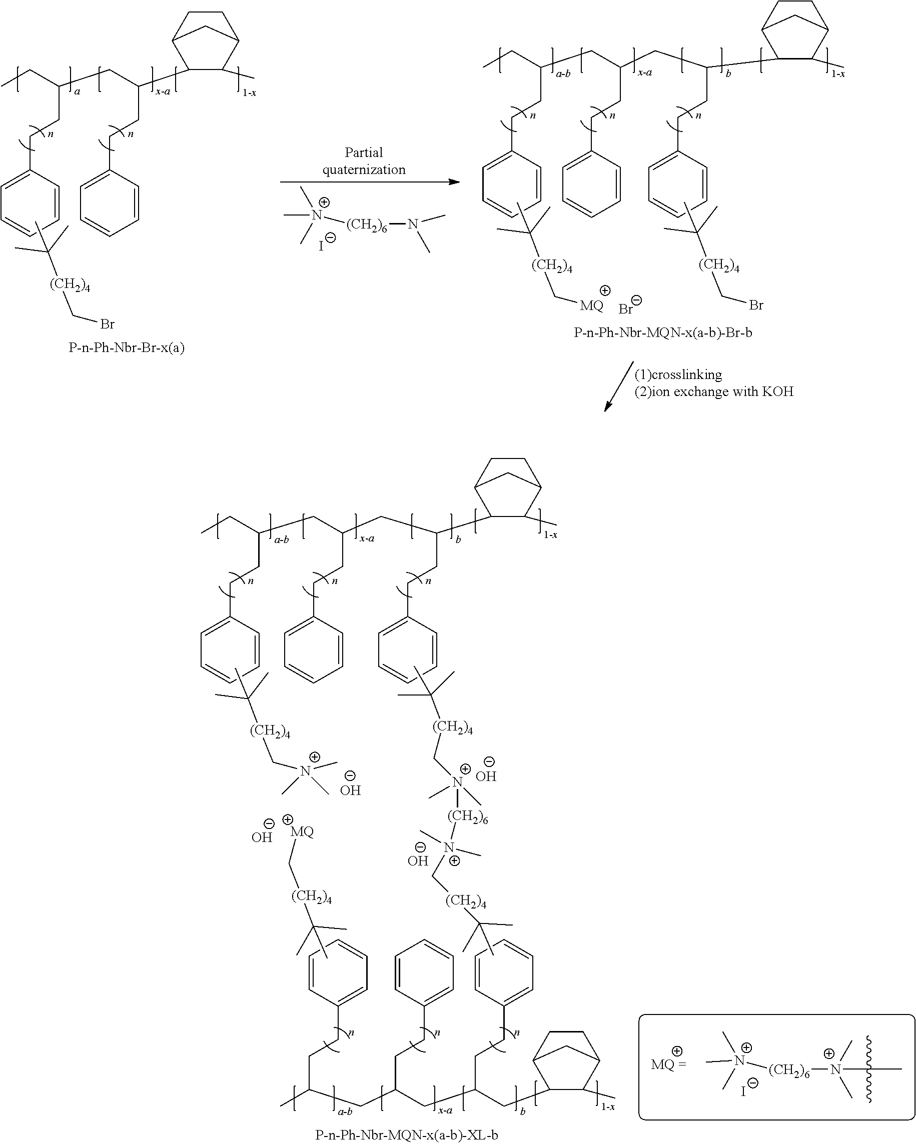

The preparation of the crosslinked polymer/membrane P-1-Ph-Nbr-MQN-0.85(0.6)-XL-0.1 is similar to that of Example 8.

### Example 11

A non-crosslinked anion exchange copolymer/membrane referred to as P-n-Ph-Nbr-IM-x(a) (n is an integer from 1 to 20; x is the ratio of phenyl containing repeating unit in the polymer and is from 0 to 1; a is the ratio of the repeating unit having functionalized phenyl and is from 0 to 1) was prepared by steps: (1) synthesis of the copolymer, P-n-Ph-Nbr-IM-x(a), (2) membrane casting and hydroxide ion exchange. The general reaction scheme is depicted below:

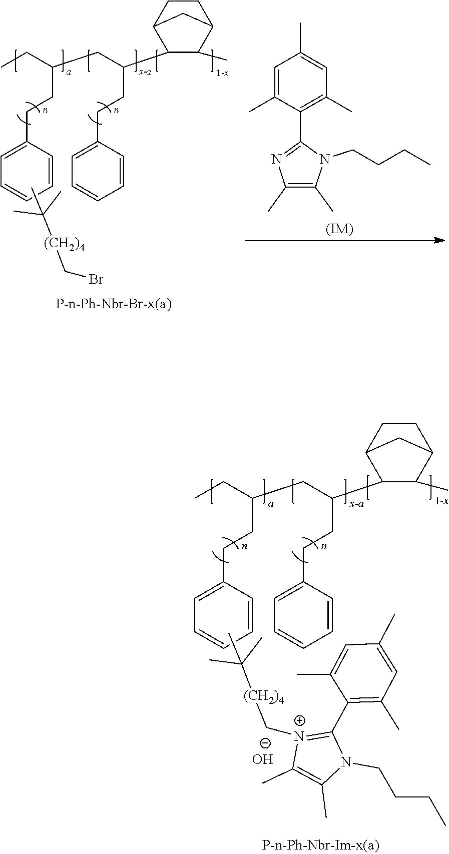

The preparation of the polymer/membrane: P-1-Ph-Nbr-IM-0.85(0.7) is similar to that of Example 7.

### Example 12

A crosslinked polymer, P-n-Ph-Nbr-IM-x(a-b)-XL-b (n is an integer from 1 to 20; x is the ratio of phenyl containing repeating unit in the polymer and is from 0 to 1; a is the ratio of the bromoalkylated repeating unit and is from 0 to 1, b is theoretical crosslinking degree), was prepared from P-n-Ph-Nbr-Br-x(a) polymer by two major steps: (1) synthesis of a partially quaternized polymer, P-n-Ph-Nbr-IM-x(a-b) (2) membrane casting with a crosslinking reagent and hydroxide ion exchanging to obtain the crosslinked membrane P-n-Ph-Nbr-IM-x(a-b)-XL-b. The reaction scheme is depicted below. The preparation of the crosslinked polymer/membrane P-1-Ph-Nbr-IM-0.85(0.6)-XL-0.1 is similar to that of Example 8.

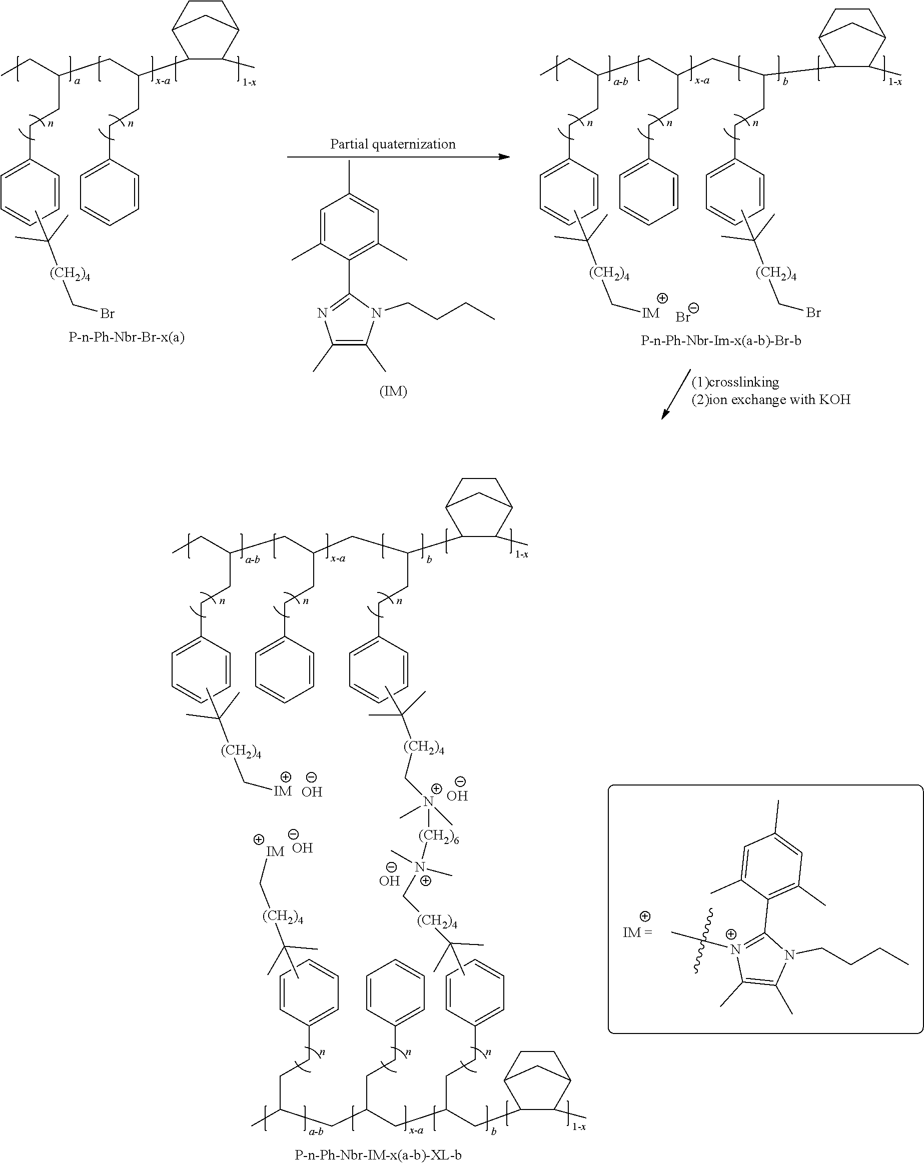

### Example 13

A non-crosslinked phenyl-substituted polyolefin anion exchange membrane (referred to as P-n-Ph-2TMA-x, n is an integer from 1 to 20; x is the ratio of phenyl that was functionalized and is from 0 to 1) was prepared from a phenyl-substituted alkene monomer by three major steps: (1) synthesis of a phenyl-substituted polyolefin polymer, P-n-Ph, (2) synthesis of the bromoalkylated polyolefin polymer, P-n-2Br-x, (3) synthesis of the quaternized polyolefin polymer, P-n-Ph-2TMA-x, and membrane casting and hydroxide ion exchange. The general reaction scheme is depicted below:

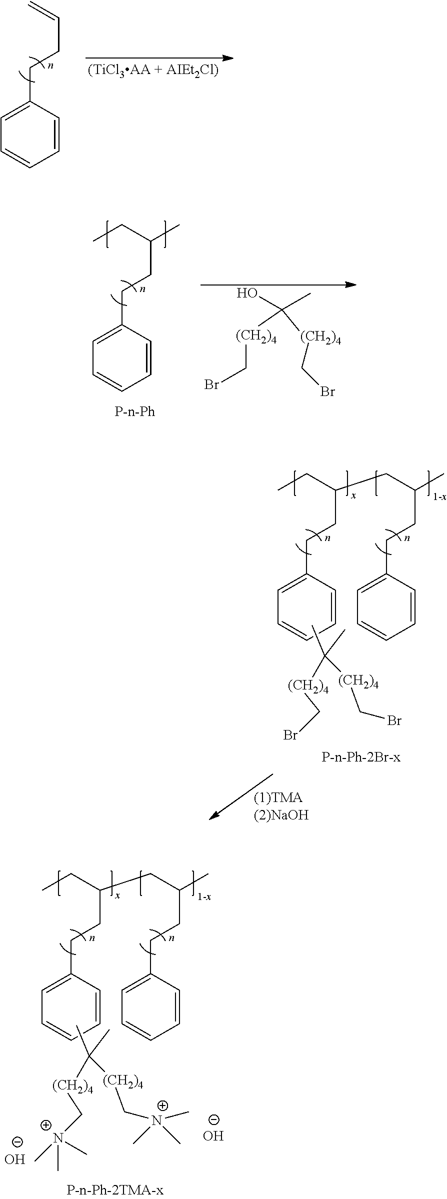

The preparation of the polymer/membrane: P-n-Ph-2TMA-0.36 is similar to that of example 1.

### Example 14

Crosslinked polymer, P-n-Ph-2TMA-x(a)-XL, was prepared from P-n-Ph-2Br-x polymer by two major steps: (1) synthesis of a partially quaternized polymer, P-n-Ph-2TMA-x(a), (x is the ratio of phenyl that was functionalized and is from 0 to 1; a is the ratio of phenyl that has di-cation-side chain and is from 0 to 1; n is an integer from 0-20), (2) membrane casting with a crosslinking reagent and hydroxide ion exchanging to obtain the crosslinked membrane P-n-Ph-2TMA-x(a)-XL. The reaction scheme is depicted below.

The preparation of the crosslinked polymer/membrane: P-n-Ph-2TMA-0.36(0.24)-XL is similar to that of Example 2.

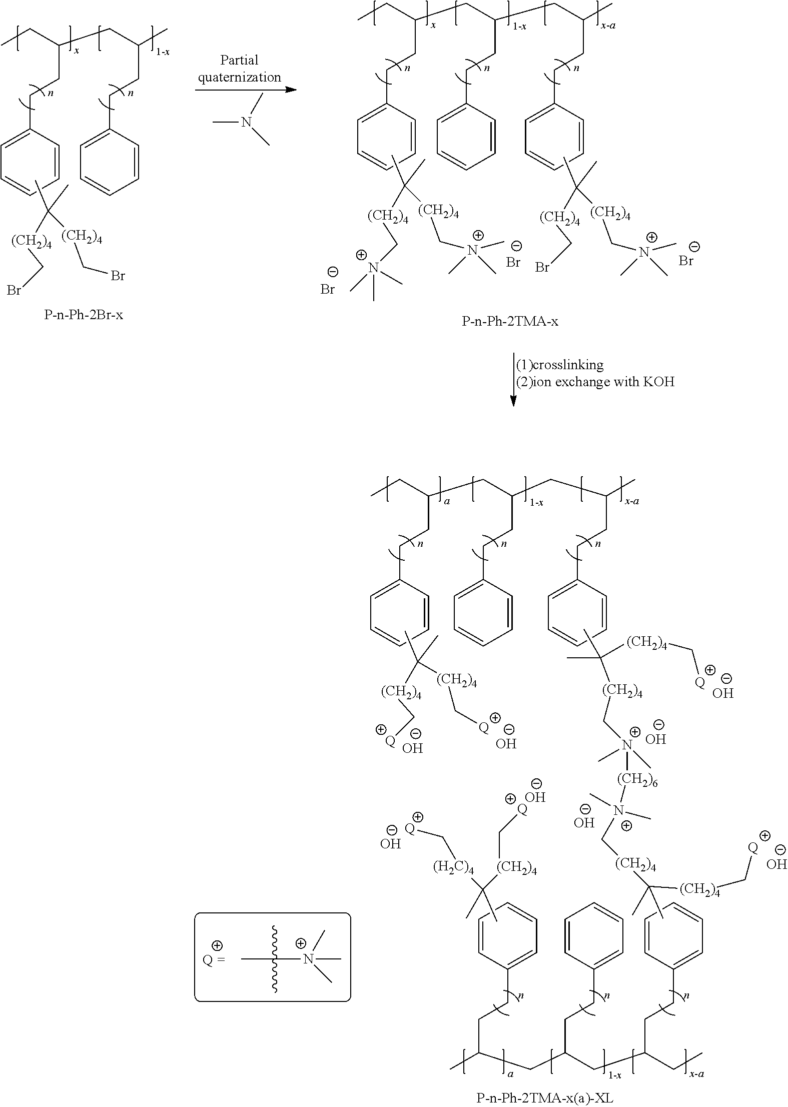

### Example 15

A non-crosslinked anion exchange copolymer/membrane referred to as P-n-Ph-Nbr-2TMA-x(a) (n is an integer from 1 to 20; x is the ratio of phenyl containing repeating unit in the polymer and is from 0 to 1; a is the ratio of the repeating unit having functionalized phenyl and is from 0 to 1) was prepared by steps: (1) synthesis of the copolymer, P-n-Ph-Nbr-2Br-x(a), (2) membrane casting and hydroxide ion exchange. The preparation of the polymer/membrane: P-n-Ph-Nbr-2TMA-0.85(0.35) is similar to that of Example 7. The general reaction scheme is depicted below:

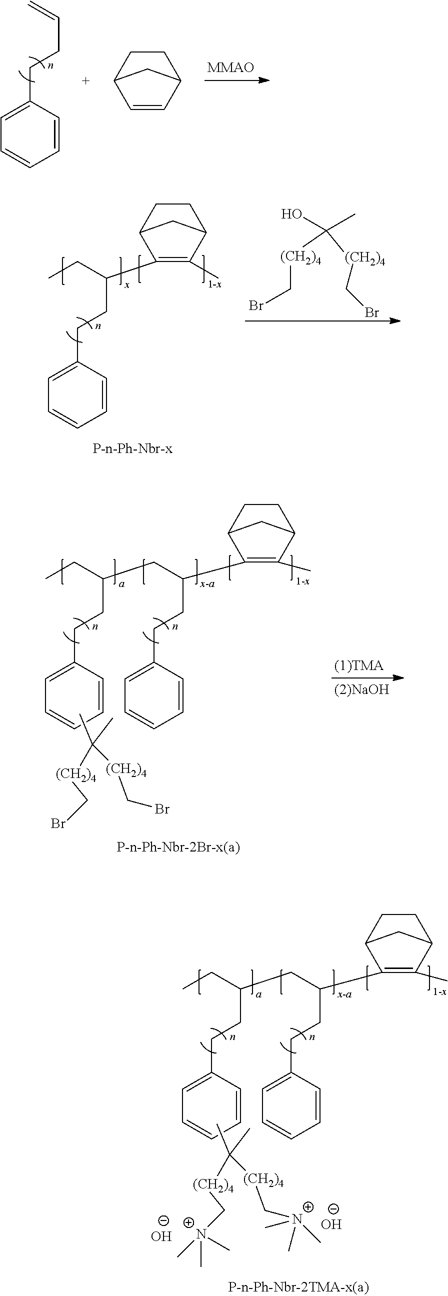

### Example 16

A crosslinked polymer, P-n-Ph-Nbr-2TMA-x(a-b)-XL-b (n is an integer from 1 to 20; x is the ratio of phenyl containing repeating unit in the polymer and is from 0 to 1; a is the ratio of the bromoalkylated repeating unit and is from 0 to 1, b is theoretical crosslinking degree), was prepared from P-n-Ph-Nbr-2Br-x(a) polymer by two major steps: (1) synthesis of a partially quaternized polymer, P-n-Ph-Nbr-2TMA-x(a-b)-Br-b (2) membrane casting with a crosslinking reagent and hydroxide ion exchanging to obtain the crosslinked membrane P-n-Ph-Nbr-2TMA-x(a-b)-XL-b. The reaction scheme is depicted below:

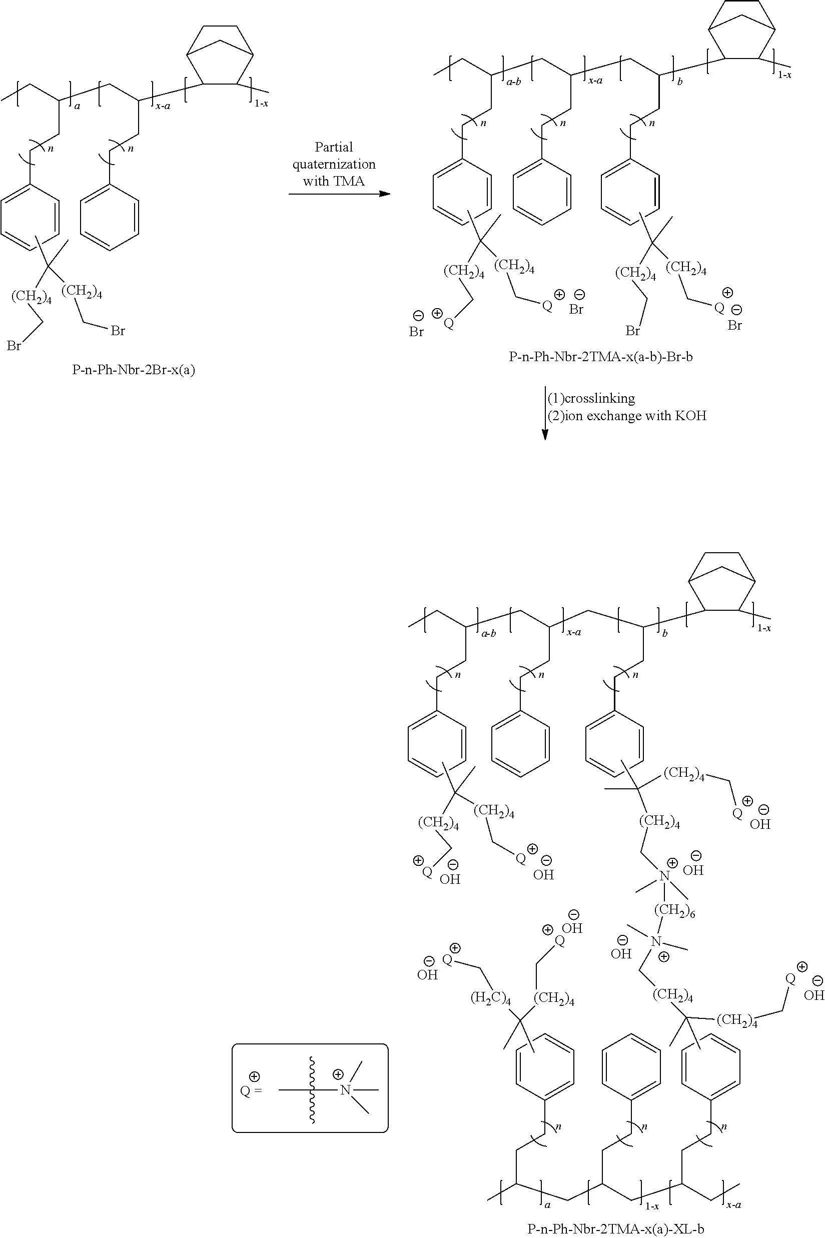

The preparation of the crosslinked polymer/membrane: P-n-Ph-Nbr-2TMA-0.85(0.25)-XL-0.1 is similar to that of Example 8.

### Definitions

The alkenes used herein can have a cis, trans, E or Z configuration.

The term “alkyl,” as used herein, refers to a linear, branched or cyclic hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons), and more preferably having 1 to 18 carbon atoms. Alkyl groups include, but are not limited to, methyl, ethyl, n-propyl, isopropyl, n-butyl, iso-butyl, secondary-butyl, and tertiary-butyl. Alkyl groups can be unsubstituted or substituted by one or more suitable substituents.

The term “alkenyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon double bonds. Alkenyl groups include, but are not limited to, ethenyl, 1-propenyl, 2-propenyl (allyl), iso-propenyl, 2-methyl-1-propenyl, 1-butenyl, and 2-butenyl. Alkenyl groups can be unsubstituted or substituted by one or more suitable substituents, as defined above.

The term “alkynyl,” as used herein, refers to a straight, branched or cyclic hydrocarbon radical, preferably having 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons, more preferably having 1 to 18 carbon atoms, and having one or more carbon-carbon triple bonds. Alkynyl groups include, but are not limited to, ethynyl, propynyl, and butynyl. Alkynyl groups can be unsubstituted or substituted by one or more suitable substituents, as defined above.

The term “aryl” or “ar,” as used herein alone or as part of another group (e.g., aralkyl), means monocyclic, bicyclic, or tricyclic aromatic radicals such as phenyl, naphthyl, tetrahydronaphthyl, indanyl and the like; optionally substituted by one or more suitable substituents, preferably 1 to 5 suitable substituents, as defined above. The term “aryl” also includes heteroaryl.

“Arylalkyl” or “aralkyl” means an aryl group attached to the parent molecule through an alkylene group. The number of carbon atoms in the aryl group and the alkylene group is selected such that there is a total of about 6 to about 18 carbon atoms in the arylalkyl group. A preferred arylalkyl group is benzyl.

The term “cycloalkyl,” as used herein, refers to a mono, bicyclic or tricyclic carbocyclic radical (e.g., cyclopropyl, cyclobutyl, cyclopentyl, cyclohexyl, cycloheptyl, cyclooctyl, cyclononyl, cyclopentenyl, cyclohexenyl, bicyclo[2.2.1]heptanyl, bicyclo[3.2.1]octanyl and bicyclo[5.2.0]nonanyl, etc.); optionally containing 1 or 2 double bonds. Cycloalkyl groups can be unsubstituted or substituted by one or more suitable substituents, preferably 1 to 5 suitable substituents, as defined above.

The term “-ene” as used as a suffix as part of another group denotes a bivalent radical in which a hydrogen atom is removed from each of two terminal carbons of the group, or if the group is cyclic, from each of two different carbon atoms in the ring. For example, alkylene denotes a bivalent alkyl group such as ethylene (—CH₂CH₂—) or isopropylene (—CH(CH₃)CH₂—). For clarity, addition of the -ene suffix is not intended to alter the definition of the principal word other than denoting a bivalent radical. Thus, continuing the example above, alkylene denotes an optionally substituted linear saturated bivalent hydrocarbon radical.

The term “hydrocarbon” as used herein describes a compound or radical consisting exclusively of the elements carbon and hydrogen.

The term “substituted” means that in the group in question, at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(-N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. When the term “substituted” introduces or follows a list of possible substituted groups, it is intended that the term apply to every member of that group. That is, the phrase “optionally substituted alkyl or aryl” is to be interpreted as “optionally substituted alkyl or optionally substituted aryl.” Likewise, the phrase “alkyl or aryl optionally substituted with fluoride” is to be interpreted as “alkyl optionally substituted with fluoride or aryl optionally substituted with fluoride.”

The term “suitable substituent,” as used herein, is intended to mean a chemically acceptable functional group, preferably a moiety that does not negate the activity of the inventive compounds. Such suitable substituents include, but are not limited to halo groups, perfluoroalkyl groups, perfluoroalkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxycarbonyl groups, alkylsulfonyl groups, and arylsulfonyl groups. Those skilled in the art will appreciate that many substituents can be substituted by additional substituents.

The term “tethered” means that the group in question is bound to the specified polymer backbone. For example, an imidazolium-tethered poly (aryl alkylene) polymer is a polymer having imidazolium groups bound to a poly (aryl alkylene) polymer backbone.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved, and other advantageous results attained.

As various changes could be made in the above products and methods without departing from the scope of the invention, it is intended that all matter contained in the above description and shown in the accompanying drawings shall be interpreted as illustrative and not in a limiting sense.

1. An anion exchange polymer comprising:
structural units of formulae 1 A, optionally 1C and optionally 1D; or
structural units of formulae 1A, 1B, optionally 1C and optionally 1D; and
wherein:
a sum of mole fractions of the structural units of Formulae 1B, 1C and 1D to mole fraction of formula 1A is from 0 to 100, and Formulae 1A, 1B, 1C and 1D have structures: 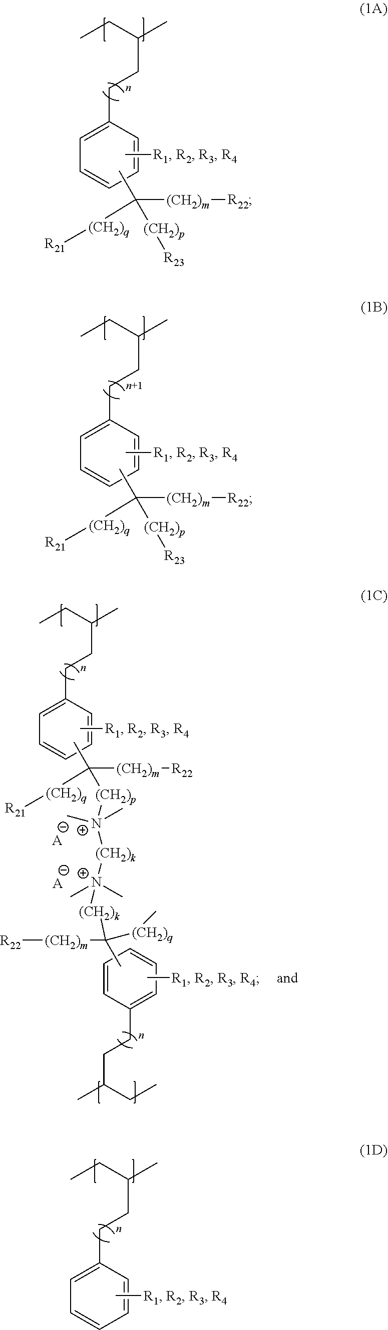
wherein:
R₁, R₂, R₃, and R₄ are each independently hydrogen, halide, alkyl, alkenyl, alkynyl or aryl, and the alkyl, alkenyl, alkynyl or aryl are optionally substituted with halide;
each R₂₁ is independently a nitrogen-containing heterocyclic group, or a quaternary ammonium or phosphonium group having the formula (1S): 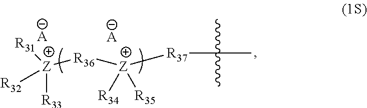
the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
R₃₁, R₃₂, R₃₃, R₃₄ and R₃₅ are each independently alkyl, alkenyl, alkynyl or aryl;
R₃₆ and R₃₇ are each independently alkylene;
k, m, n, p, q, and s are each independently an integer from 0 to 20;
A⁻ is an anion; and
Z is N or P.

2. A haloalkylated polymer comprising a second reaction product of a second polymerization mixture comprising an intermediate polymer and a haloalkylating reagent having the formula (2S): 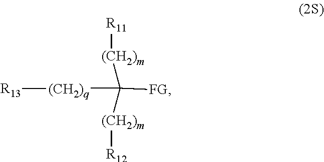
wherein the intermediate polymer comprises a first reaction product of a first polymerization mixture comprising
(i) a phenyl-substituted alkene monomer having the formula: 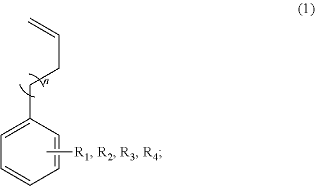
and
(ii) optionally, a second phenyl-substituted alkene monomer having the formula; 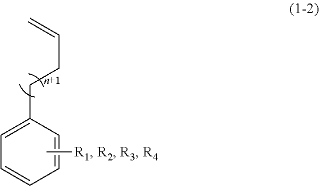
wherein:
R₁, R₂, R₃ and R₄ are each independently hydrogen, halide, alkyl, alkenyl, alkynyl or aryl, and the alkyl, alkenyl, alkynyl or aryl are optionally substituted with halide;
each FG is independently hydroxyl, alkenyl, alkynyl or aryl, and the alkenyl, alkynyl or aryl are optionally substituted with halide;
each Ru 1 is independently halide or substituent (3S): 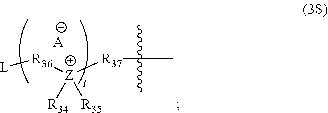
R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
L is halide;
m, n, p, q and t are each independently an integer from 0 to 20; and
Z is N or P.

3. An anion exchange polymer comprising:
structural units of formulae 1A, 2A, optionally 1C, optionally 1D, and optionally 3A; or
structural units of formulae 1A, 3A, optionally 1C and optionally 1D;
wherein:
a sum of mole fractions of the structural units of formulae 2A, 1C, 1D and 3A to mole fraction of formula 1A in the polymer is from 0.01 to 100, wherein the structural units of formulae 1 A, 1C, 1D, 2A and 3A are: 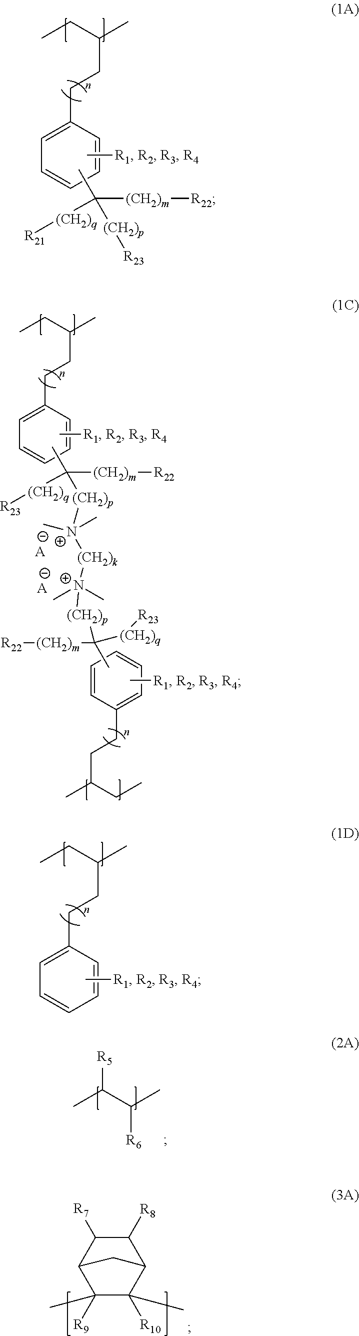
wherein:
R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or R₇ and R₈ are optionally linked to form a 4-, 5-, 6- or 7-membered ring optionally substituted with halide or alkyl, or to form a bicyclic compound optionally substituted with halide;
R₅ and R₆ are each independently hydrogen, halide, alkyl, alkenyl or alkynyl and the alkyl, alkenyl or alkynyl are optionally substituted with halide, or R₅ and R₆ are optionally linked to form a 4-, 5-, 6- or 7-membered ring optionally substituted with halide or alkyl;
each R₂₁ is independently a nitrogen-containing heterocyclic group or a quaternary ammonium or phosphonium group having the formula (1S), 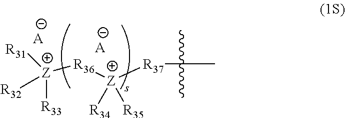
and the nitrogen-containing heterocyclic group being an optionally substituted pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₂₂ and R₂₃ are each independently hydrogen, alkyl, alkenyl, alkynyl, aryl, the nitrogen-containing heterocyclic group, or the quaternary ammonium or phosphonium group having the formula (1S), and the alkyl, alkenyl, alkynyl or aryl are optionally substituted with halide;
R₃₁, R₃₂, R₃₃, R₃₄ and R₃₅ are each independently alkyl, alkenyl, alkynyl or aryl;
R₃₆ and R₃₇ are each independently alkylene;
A⁻ is an anion;
k, m, n, p, q and s are each independently an integer from 0 to 20; and
Z is N or P.

4. A haloalkylated polymer comprising a second reaction product of a second polymerization mixture comprising an intermediate polymer and a haloalkylating reagent having formula (2S): 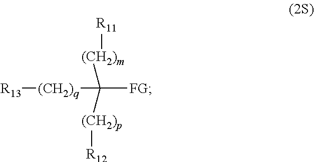
wherein the intermediate polymer comprises a first reaction product of a first polymerization mixture comprising either:
(i) a phenyl-substituted alkene monomer having formula (1), an alkene monomer having formula (2); and optionally, a norbornene monomer or derivative thereof having formula (3); or
(ii) the phenyl-substituted alkene monomer having formula (1), the norbornene monomer or derivative thereof having formula (3), and optionally, the alkene monomer having formula (2);
wherein:
the phenyl-substituted alkene monomer having formula (1) is: 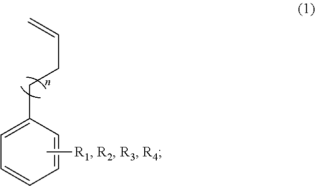
the alkene monomer having formula (2) is: 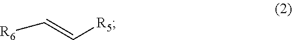
and
the norbornene monomer or derivative thereof having formula (3) is: 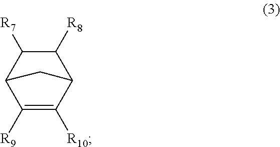
R₁, R₂, R₃, R₄, R₇, R₈, R₉, and R₁₀ are each independently hydrogen, halide, alkyl, alkenyl, alkynyl or aryl, and the alkyl, alkenyl, alkynyl or aryl are optionally substituted with halide, or wherein R₇ and R₈ are optionally linked to form a 4-, 5-, 6- or 7-membered ring optionally substituted with halide or alkyl or to form a bicyclic compound optionally substituted with halide;
R₅ and R₆ are each independently hydrogen, halide, alkyl, alkenyl or alkynyl and the alkyl, alkenyl or alkynyl are optionally substituted with halide, or wherein R₅ and R₆ are optionally linked to form a 4-, 5-, 6- or 7-membered ring optionally substituted with halide or alkyl;
each Ru 1 is independently halide or substituent (3S): 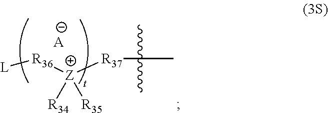
R₁₂ and R₁₃ are each independently hydrogen, halide, alkyl, alkenyl, alkynyl, aryl, or the substituent (3S);
R₃₄ and R₃₅ are each independently alkyl, alkenyl, alkynyl or aryl;
R₃₆ and R₃₇ are each independently alkylene;
A− is an anion;
each FG is independently hydroxyl, alkenyl, alkynyl or aryl, and the alkenyl, alkynyl or aryl are optionally substituted with halide;
L is halide;
m, n, p, q and t are each independently an integer from 0 to 20; and
Z is N or P.

5. The polymer of claim of 1, wherein the sum of the mole fractions of the structural units of formulae 1B, 1C and 1D to the mole fraction of formula 1A is from 0.1 to 10.

6. The polymer of claim 1, comprising the structural units of formulae 1A and 1C.

7. The polymer of claim 1, comprising the structural units of formulae 1A and 1D.

8. The polymer of claim 1, comprising the structural units of formulae 1A and 1B.

9. The polymer of claim 1, comprising the structural units of formulae 1A, 1C and 1D.

10. The polymer of claim 1, comprising the structural units of formulae 1 A, 1B, 1C and 1 D.

11. (canceled)

12. The polymer of claim 1, comprising the structural units of formulae 1A, 1B and 1C.

13. The polymer of claim 1, comprising the structural units of formulae 1A, 1B and 1D.

14. (canceled)

15. The polymer of claim 1, wherein R₁, R₂, R₃ and R₄ of the structural unit of formula (1A), (1B), (1C) or (1D) are each independently hydrogen or alkyl.

16. The polymer of claim 1, wherein each R₂₁ of the structural unit of formula (1A), (1B) or (1C) is independently the nitrogen-containing heterocyclic group; and R₂₂ and R₂₃ are each independently hydrogen or alkyl; or
each R₂₁ of the structural unit of formula (1A), (1B) or (1C) is independently the quaternary ammonium or phosphonium group of the formula (1S); and R₂₂ and R₂₃ are each independently hydrogen or alkyl,
wherein R₃₁, R₃₂, R₃₃, R₃₄ and R₃₅ of the quaternary ammonium or phosphonium group having the formula (1S) are each independently alkyl; R₃₆ and R₃₇ are each independently alkylene; each s is independently an integer from 0 to 4; A⁻ is halide; Z is N or P.

17.-18. (canceled)

19. The polymer of claim 16, wherein the quaternary ammonium or phosphonium group having the formula (1S) is:

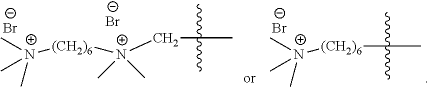

20.-25. (canceled)

26. A polymer comprising a reaction product of a quaternization reagent and the haloalkylated polymer of claim 2.

27. A polymer comprising a reaction product of an ion exchange solution and the polymer of claim 26.

28. The polymer of claim 2, wherein the haloalkylating reagent of formula (2S) has each FG being independently hydroxyl or alkenyl; each R₁ 1 being independently halide or the substituent (3S); R₁₂ and R₁₃ being each independently halide, alkyl or the substituent (3S) wherein R₃₄ and R₃₅ are each independently alkyl.

29. The polymer of claim 2, wherein the haloalkylating reagent of formula (2S) is

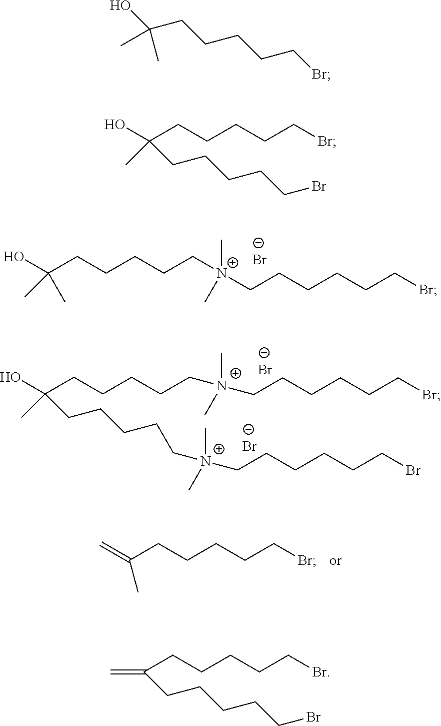

30. The polymer of claim 26, wherein the quaternization reagent is a nitrogen-containing group, a phosphorus-containing group or a quaternary ammonium or phosphonium group having formula (4S): 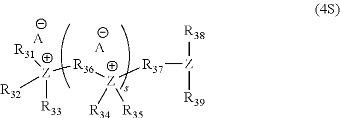
and the nitrogen-containing group being an optionally substituted amine, phosphine, pyrrole, pyrroline, pyrazole, pyrazoline, imidazole, imidazoline, triazole, pyridine, triazine, pyrazine, pyridazine, pyrimidine, azepine, quinoline, piperidine, pyrrolidine, pyrazolidine, imidazolidine, azepane, isoxazole, isoxazoline, oxazole, oxazoline, oxadiazole, oxatriazole, dioxazole, oxazine, oxadiazine, isoxazolidine, morpholine, thiazole, isothiazole, oxathiazole, oxathiazine, or caprolactam, wherein each substituent is independently alkyl, alkenyl, alkynyl, aryl, or aralkyl;
R₃₁, R₃₂, R₃₃, R₃₄, R₃₅, R₃₈ and R₃₉ are each independently alkyl, alkenyl, alkynyl or aryl;
R₃₆ and R₃₇ are each independently alkylene;
A− is an anion;
L is halide;
s is each independently an integer from 0 to 20; and
Z is N or P.

31. The polymer of claim 30, wherein the quaternization reagent is the quaternary ammonium or phosphonium group having formula (4S) wherein R₃₁, R₃₂, R₃₃, R₃₄, R₃₅, R₃₈ and R₃₉ being each independently alkyl; and s being each independently an integer from 0 to 3.

32. The polymer of claim 26, wherein the quaternization reagent is 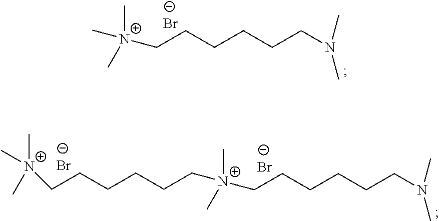
or an imidazole of formula (4S-1): 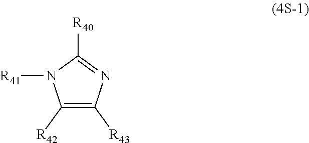
wherein:
R₄₀, R₄₁, R₄₂ and R₄₃ are each independently hydrogen, alkyl, alkenyl, alkynyl or aryl, and the alkyl, alkenyl, alkynyl or aryl are optionally substituted with halide.

33.-34. (canceled)

35. The polymer of claim 32, wherein the imidazole of formula (4S-1) is

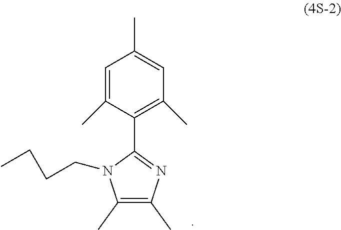 [SMILES: CCCCn1c(-c2c(C)cc(C)cc2C)nc(C)c1C]

36. The polymer of claim 2, wherein in the phenyl-substituted alkene monomer having formula (1), R₁, R₂, R₃ and R₄ are each independently hydrogen, halide, or C₁-C₆ alkyl, and the alkyl is optionally substituted with halide; or
wherein the phenyl-substituted alkene monomer having formula (1) comprises 6-phenyl-1-butene, 5-phenyl-1-butene, 4-phenyl-1-butene, 3-phenyl-1-butene or any combination thereof.

37.-41. (canceled)

42. The polymer of claim 1, wherein A⁻ is an anion comprising halide, carbonate, bicarbonate, hydroxide, trifluoroacetate, acetate, triflate, methanesulfonate, sulfate, nitrate, tetrafluoroborate, hexafluorophosphate, formate, benzenesulfonate, toluate, perchlorate, benzoate or any combination thereof.

43. The polymer of claim 1, wherein Z is N.

44. The polymer of claim 1, wherein Z is P.

45.-50. (canceled)

51. A method of making a hot-pressed electrode, the method comprising:
mixing an electrocatalyst with an anion exchange polymer solution comprising the polymer of claim 26 to form an electrode ink;
coating the electrode ink onto a substrate comprising carbon paper to form an electrode;
drying the electrode; and
applying pressure on the dried electrode at a temperature ranging from 70 to 200° C. to form a hot-pressed electrode.

52. A method of making a hot-pressed membrane electrode assembly, the method comprising:
mixing an electrocatalyst with an anion exchange polymer solution comprising the polymer of claim 26 to form an electrode ink;
coating the electrode ink onto a substrate comprising carbon paper to form an electrode;
drying the electrode;
applying pressure on the dried electrode at a temperature ranging from 70 to 200° C. to form a hot-pressed electrode;
sandwiching an anion exchange membrane with the hot-pressed electrode to form the hot-pressed membrane electrode assembly; and
optionally, applying pressure on the hot-pressed membrane electrode assembly at a temperature ranging from 70 to 200° C. to finish the assembly.

53. A method of making a hot-pressed membrane electrode assembly, the method comprising:
mixing an electrocatalyst with an anion exchange polymer solution comprising the polymer of claim 26 to form an electrode ink;
coating the electrode ink onto a substrate comprising an anion exchange membrane to form an electrode membrane assembly;
drying the electrode membrane assembly; and
applying pressure on the dried electrode membrane assembly at a temperature ranging from 70 to 200° C. to form a hot-pressed electrode membrane assembly.

54. A method of making a hot-pressed and crosslinked electrode, the method comprising:
mixing an electrocatalyst with a crosslinkable anion exchange polymer solution comprising the polymer of claim 26 to form an electrode ink;
mixing a crosslinking reagent and the electrode ink to form a crosslinkable electrode ink;
coating the crosslinkable electrode ink onto a substrate comprising carbon paper to form an electrode;
drying the electrode; and
applying pressure on the dried electrode at a temperature ranging from 70 to 200° C. to form the hot-pressed and crosslinked electrode.

55. A method of making a hot-pressed and crosslinked membrane electrode assembly, the method comprising:
mixing an electrocatalyst with a crosslinkable anion exchange polymer solution comprising the polymer of claim 26 to form an electrode ink;
mixing a crosslinking reagent and the electrode ink to form a crosslinkable electrode ink;
coating the crosslinkable electrode ink onto a substrate comprising carbon paper to form a crosslinkable electrode;
drying the electrode;
applying pressure on the dried electrode at a temperature ranging from 70 to 200° C. to form a hot-pressed and crosslinked electrode;
sandwiching an anion exchange membrane with the hot-pressed and crosslinked electrode to form the hot-pressed and crosslinked membrane electrode assembly; and
optionally, applying pressure on the membrane electrode assembly at a temperature ranging from 70 to 200° C. to finish the assembly.

56. A method of making a hot-pressed and crosslinked electrode membrane electrode assembly, the method comprising:
mixing an electrocatalyst with a crosslinkable anion exchange polymer solution comprising the polymer of claim 26 to form an electrode ink;
mixing a crosslinking reagent and the electrode ink to form a crosslinkable electrode ink,
coating the crosslinkable electrode ink onto a substrate comprising an anion exchange membrane to form a crosslinkable electrode membrane assembly;
drying the crosslinkable electrode membrane assembly; and
applying pressure on the dried crosslinkable electrode membrane assembly at a temperature ranging from 70 to 200° C. to form the hot-pressed and crosslinked electrode membrane assembly.

57. The method of any one of claim 54, wherein the crosslinking reagent has the formula: 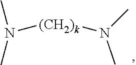
wherein k is an integer from 3 to 10; or
wherein the crosslinking reagent comprises N,N,N′,N′-tetramethyl-1,6-hexanediamine, N,N,N′,N′-tetramethyl-1,4-butanediamine, N,N,N′,N′-tetramethyl-1,3-propanediamine, or any combination thereof.

58.-59. (canceled)

60. An anion exchange membrane configured and sized to be suitable for use in a fuel cell, electrolyzer, electrodialyzer, solar hydrogen generator, flow battery, desalinator, sensor, demineralization of water, ultra-pure water production, wastewater treatment, ion exchanger, or CO₂ separator, and comprising the polymer of claim 1.

61. An anion exchange membrane fuel cell, electrolyzer, electrodialyzer, solar hydrogen generator, flow battery, desalinator, sensor, demineralization of water, ultra-pure water production, wastewater treatment, ion exchanger, or CO₂ separator comprising the polymer of claim 1.

62. A reinforced ion exchange membrane or electrolyte membrane, optionally configured and sized to be suitable for use in a fuel cell, electrolyzer, electrodialyzer, solar hydrogen generator, flow battery, desalinator, sensor, demineralizer, water purifier, waste water treatment system, ion exchanger, or CO₂ separator, and the reinforced membrane comprising a porous substrate impregnated with the polymer of claim 1.

63. The membrane of claim 62, wherein the porous substrate comprises a membrane comprised of polytetrafluoroethylene, polypropylene, polyethylene, poly(ether) ketone, polyaryletherketone, imidazole-tethered poly(aryl alkylene), imidazolium-tethered poly(aryl alkylene), polysulfone, perfluoroalkoxyalkane, or a fluorinated ethylene propylene polymer, and the membrane is optionally a dimensionally stable membrane.

64. The membrane of claim 62, wherein either:
the porous substrate has a porous microstructure of polymeric fibrils;
an interior volume of the porous substrate is rendered substantially occlusive by impregnation with the polymer;
the porous substrate comprises a microstructure of nodes interconnected by fibrils;
the porous substrate has a thickness from about 1 micron to about 100 microns;
the membrane is prepared by multiple impregnations of the substrate with the polymer; or
the membrane is prepared by:
wetting the porous substrate in a liquid to form a wetted substrate;
dissolving the polymer in a solvent to form a homogeneous solution or suspension;
applying the solution or suspension onto the wetted substrate to form the reinforced membrane; and
drying the membrane.
